(19) United States
(12) Patent Application Publication
(10) Pub. No.: US 2025/0111194 A1
(43) Pub. Date: Apr. 3, 2025

(54) METHOD AND SYSTEM TO OPTIMIZE NEURAL NETWORK SCORING

(71) Applicant: International Business Machines Corporation, Armonk, NY (US)

(72) Inventors: Dong Hai Yu, Xian (CN); Bo Song, Xian (CN); Ji Hui Yang, Beijing (CN); Jun Wang, Xian (CN); Yao Dong Liu, Xian (CN); Jiang Bo Kang, Xian (CN); Lei Tian, Xian (CN)

(21) Appl. No.: 18/476,455

(22) Filed: Sep. 28, 2023

(51) Int. Cl. G06N 3/045

(52) U.S. Cl. CPC G06N 3/045

(57) ABSTRACT

Systems, computer program products and/or computer-implemented methods described herein relate to a process to optimize performance of an operating neural network. A system can comprise a memory that stores computer executable components and a processor that executes the computer executable components, which can comprise an identification component that, employing an operating, multi-layered virtual computation module of looped neurons, identifies a first neuron of a first cluster of a first layer of the looped neurons as being an outlier neuron, an adjustment component that reassigns the outlier neuron from the first cluster to a second cluster of the first layer, and a scheduling component that, based on a dependency among layers of the multi-layered virtual computation module, including the first layer, adjusts a cross-layer functionality of the looped neurons for a workload currently being performed by the multi-layered virtual computation module.

### TECHNICAL FIELD

The present disclosure relates to achieving optimized scoring performance of a neural network model through increased neuron analysis.

### BACKGROUND

A neural network is a network or circuit of neurons and/or artificial neurons. The neurons can be comprised in one or more nodes. That is a neural network can be a biological neural network, made up of biological neurons, or an artificial neural network, such as used for solving artificial intelligence (AI) problems. Connections of a biological neuron can be modeled as weights. A positive weight can reflect an excitatory connection, while a negative weight can reflect an inhibitory connection.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide a process to optimize performance of an operating neural network.

In accordance with an embodiment, a system can comprise a memory that stores computer executable components and a processor that executes the computer executable components stored in the memory. The computer executable components comprise an identification component that, employing an operating, multi-layered virtual computation module of looped neurons, identifies a first neuron of a first cluster of a first layer of the looped neurons as being an outlier neuron; an adjustment component that reassigns the outlier neuron from the first cluster to a second cluster of the first layer; and a scheduling component that, based on a dependency among layers of the multi-layered virtual computation module, including the first layer, adjusts a cross-layer functionality of the looped neurons for a workload currently being performed by the multi-layered virtual computation module.

In accordance with another embodiment, a computer-implemented method can comprise employing, by a system comprising a memory operatively coupled to a processor, an operating, multi-layered virtual computation module of looped neurons; identifying, by the system, a first neuron of a first cluster of a first layer of the looped neurons as being an outlier neuron; reassigning, by the system, the outlier neuron from the first cluster to a second cluster of the first layer; and based on a dependency among layers of the multi-layered virtual computation module, including the first layer, adjusting, by the system, a cross-layer functionality of the looped neurons for a workload currently being performed by the multi-layered virtual computation module. In accordance with still another embodiment, a computer program product, facilitating a process for promoting green energy practices for terrace slope farming, can comprise a computer readable storage medium having program instructions embodied therewith, the program instructions executable by a processor to cause the processor to employ, by the processor, an operating, multi-layered virtual computation module of looped neurons; identify, by the processor, a first neuron of a first cluster of a first layer of the looped neurons as being an outlier neuron; reassign, by the processor, the outlier neuron from the first cluster to a second cluster of the first layer; and based on a dependency among layers of the multi-layered virtual computation module, including the first layer, adjust, by the processor, a cross-layer functionality of the looped neurons for a workload currently being performed by the multi-layered virtual computation module.

A benefit of the one or more systems, computer program products and/or computer-implemented methods can be an ability to improve neural network scoring performance through the generation and adjustment of a multi-layered variational computation module of the neural network. That is, through the layering and adjustment of cluster of layers, based on reassigning of neurons being outliers to their initial clusters, speed of processing of the neural network can be increased, therefore optimizing the performance of the neural network. This performance can be optimized in real-time (e.g., during operation of the neural network for one or more workloads using the looped neurons of the neural network to provide one or more prediction results).

Another benefit of the one or more systems, computer program products and/or computer-implemented methods can be an ability to, based on adjustment of a multi-layered variational computation module of the neural network, avoid one or more bottlenecks of use of the neural network to process one or more workloads. That is, relative to single workloads, back-to-back workloads or workloads being parallelly-processed, the one or more embodiments described herein can perform real-time (e.g., rapid, during operation of the neural network) adjustment of neuron cluster association, and associated layer dependency analysis. As such, one or more neurons can be reassigned to clusters having run times that are statistically similar to one another, thus preventing a neuron that is an outlier of a cluster of neurons from impeding rapid processing by that cluster of neurons.

Still another benefit of the one or more systems, computer program products and/or computer-implemented methods can be an ability to, adjust cross layer functionality (e.g., functionality across layers of a variational computation module) based on a selected number of neurons to be employed for a workload and/or for another requirement (e.g., type of neurons, historical run time of neurons, etc.) associated with a workload.

### DESCRIPTION OF THE DRAWINGS

FIG. 1 illustrates a block diagram of an example, non-limiting system that can provide a process to optimize performance of an operating neural network, in accordance with one or more embodiments described herein.

FIG. 2 illustrates a block diagram of another example, non-limiting system that can provide a process to optimize performance of an operating neural network, in accordance with one or more embodiments described herein.

FIG. 3 provides a flow diagram of an ordering of use of the non-limiting system of FIG. 2, in accordance with one or more embodiments described herein.

FIG. 4 provides a flow diagram of a set of process that can be performed by the non-limiting system of FIG. 2, in accordance with one or more embodiments described herein.

FIG. 5 illustrates a derived table that can be formed by the processes of FIG. 4, in accordance with one or more embodiments described herein.

FIG. 6 provides a flow diagram of a set of process that can be performed by the non-limiting system of FIG. 2, in accordance with one or more embodiments described herein.

FIG. 7 illustrates a neural layer table that can be formed by the processes of FIG. 4, in accordance with one or more embodiments described herein.

FIG. 8 illustrates a schematic of clustering of neurons in a first layer of a variational computation module as generated by the non-limiting system of FIG. 2, in accordance with one or more embodiments described herein.

FIG. 9 illustrates a flow diagram of a set of process that can be performed by the non-limiting system of FIG. 2, in accordance with one or more embodiments described herein.

FIG. 10 illustrates a flow diagram of initial operation of a first layer of a variational computation module as generated by the non-limiting system of FIG. 2, in accordance with one or more embodiments described herein.

FIG. 11 illustrates a schematic of clustering of neurons in a second layer of a variational computation module as generated by the non-limiting system of FIG. 2, in accordance with one or more embodiments described herein.

FIG. 12 illustrates a schematic of clustering of neurons in an Nth layer of a variational computation module as generated by the non-limiting system of FIG. 2, in accordance with one or more embodiments described herein.

FIG. 13 illustrates a flow diagram of initial operation of the Nth layer of a variational computation module as generated by the non-limiting system of FIG. 2, in accordance with one or more embodiments described herein.

FIG. 14 illustrates a set of processes related to elapsed time analysis that can be performed by the non-limiting system of FIG. 2, in accordance with one or more embodiments described herein.

FIG. 15 illustrates a set of processes related to elapsed time analysis that can be performed by the non-limiting system of FIG. 2, in accordance with one or more embodiments described herein.

FIG. 16 illustrates a set of processes related to cluster analysis that can be performed by the non-limiting system of FIG. 2, in accordance with one or more embodiments described herein.

FIG. 17 illustrates a set of processes related to outlier neuron cancellation based on the cluster analysis that can be performed by the non-limiting system of FIG. 2, in accordance with one or more embodiments described herein.

FIG. 18 illustrates a set of processes related to outlier neuron reassignment based on the cluster analysis that can be performed by the non-limiting system of FIG. 2, in accordance with one or more embodiments described herein.

FIG. 19 illustrates a flow diagram of subsequent operation of the Nth layer of a variational computation module as generated by the non-limiting system of FIG. 2, in accordance with one or more embodiments described herein.

FIG. 20 illustrates a flow diagram of exemplary definition of relationship between neurons of different layers of the variational computation module, based on the outlier neuron reassignment, in accordance with one or more embodiments described herein.

FIG. 21 illustrates a flow diagram of exemplary adjustment of neuron operation order, based on the outlier neuron reassignment, in accordance with one or more embodiments described herein.

FIG. 22 illustrates a flow diagram of subsequent operation of the Nth layer of a variational computation module as generated by the non-limiting system of FIG. 2, in accordance with one or more embodiments described herein.

FIG. 23 illustrations a flow diagram of one or more processes that can be performed by the non-limiting system of FIG. 2, in accordance with one or more embodiments described herein.

FIG. 24 illustrates a continuation of the flow diagram of FIG. 23 of one or more processes that can be performed by the non-limiting system of FIG. 2, in accordance with one or more embodiments described herein.

FIG. 25 illustrates a block diagram of example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Performance of a prediction by a neural network (NN) often can take an undesired amount of time. This can particularly be the case when a neural network is performing real-time scoring. As used herein, real-time scoring can refer to rapid scoring (e.g., immediately responsive), such as in a time range of a millisecond to tens of milliseconds, by the neural network. Non-limiting example instances can include financial analysis or medical treatment analysis. In one or more cases, such rapid scoring can be employed during and/or in connection with performance of one or more other processes using and/or based on an output of the rapid scoring. Performance of such real-time scoring can be desired in various cases due to timeliness or urgency of use of the results.

One type of neural network can be a neural network generated based on an ensemble method. An ensemble method can comprise generating a plurality of separate neural network models and then combining the separate neural network models. Examples of such ensemble models can include, but are not limited to, random trees, XG Boost or LightGBM models. Using existing approaches, this type of neural network model in particular, an ensemble model, can take an undesirable length of time in a respective prediction phase, which often cannot meet a real-time expectation of an end user. That is, rapid scoring performed by such existing ensemble models often is not immediate enough, as viewed by an end user. For example, during performance of a prediction process for an ensemble model (e.g., a neural network ensemble model), all neurons of the ensemble model can be computed, and then results thereof can be merged and passed to a next neural layer of the ensemble model.

To account for one or more of these deficiencies of existing ensemble model generation and/or use frameworks, one or more embodiments described herein can generate and employ an ensemble model that can provide optimized (e.g., enhanced and/or more rapid) response (e.g., scoring) than existing ensemble models. The one or more embodiments, to generate a final ensemble model, can extract and generate node information for all nodes in the ensemble model, analyze relationships between the nodes and for each node connection, generate a corresponding relationship from variable ID to connection, perform a plurality of forecastings using ensemble traversal at least partially in parallel with one another, and, after a period of runtime, identify one or more outlier base portions within one or more clusters of the nodes of the ensemble model, and further dynamically adjust a corresponding workload of the ensemble model by reassigning one or more of the outlier base portions in each of the parallelly operating forecastings.

As used herein, the term “dynamically adjust” can comprise automatic adjustment during operation of the forecastings being performed by an ensemble model.

More particularly, the one or more embodiments described herein can, employing the generated variational computation module having a plurality of layers, determine one or more outlier neurons at different clusters of different layers of the plurality of layers, cancel operation of those outlier neurons at the affect clusters, reassign the outlier neurons to different clusters, determine resulting relationships between neurons of the plurality of layers, readjust ordering of operation of the neurons of the different clusters of the different layers, and based thereon, perform and/or continue performing one or more prediction processes employing the adjusted variational computation module of the neural network.

By generating and employing the adjusted variational computation module of the neural network, the one or more embodiments described herein can improve neural network scoring performance. That is, through the layering and adjustment of cluster of layers, based on reassigning of neurons being outliers to their initial clusters, speed of processing of the neural network can be increased, therefore optimizing the performance of the neural network. This performance can be optimized in real-time (e.g., during operation of the neural network for one or more workloads using the looped neurons of the neural network to provide one or more prediction results).

Put another way, based on adjustment of a multi-layered variational computation module of the neural network, the one or more embodiments described herein can facilitate avoidance of one or more bottlenecks of use of the neural network to process one or more workloads. That is, relative to single workloads, back-to-back workloads or workloads being parallelly-processed, the one or more embodiments described herein can perform real-time (e.g., rapid, during operation of the neural network) adjustment of neuron cluster association, and associated layer dependency analysis. As such, one or more neurons can be reassigned to clusters having run times that are statistically similar to one another, thus preventing a neuron that is an outlier of a cluster of neurons from impeding rapid processing by that cluster of neurons.

As used herein, the term “data” can comprise metadata.

As used herein, the terms “entity,” “requesting entity,” and “user entity” can refer to a machine, device, component, hardware, software, smart device, party, organization, individual and/or human.

### Description

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

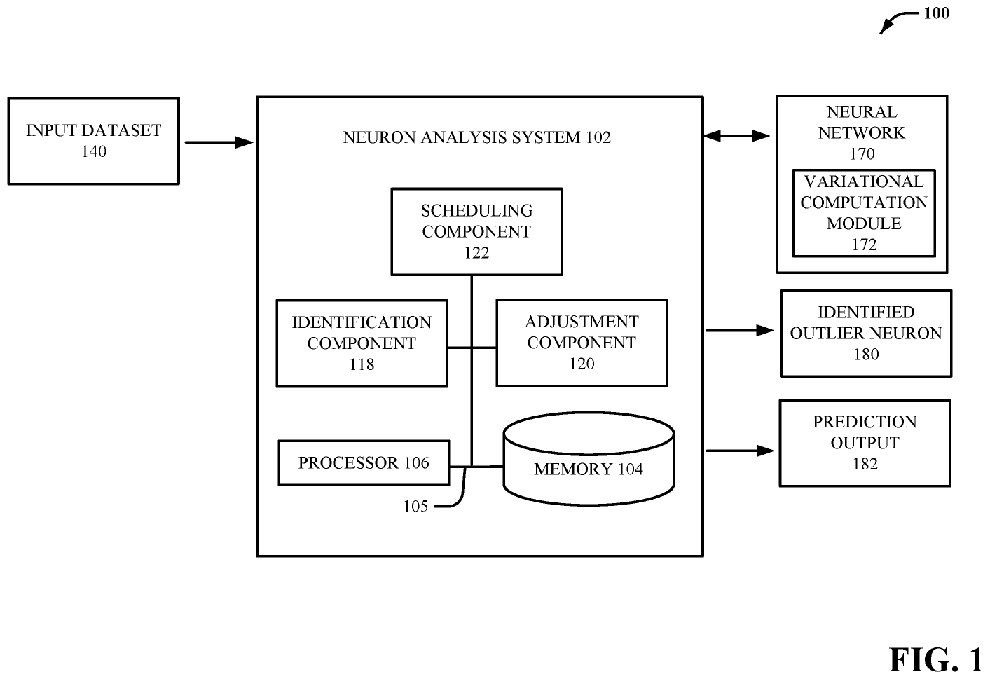

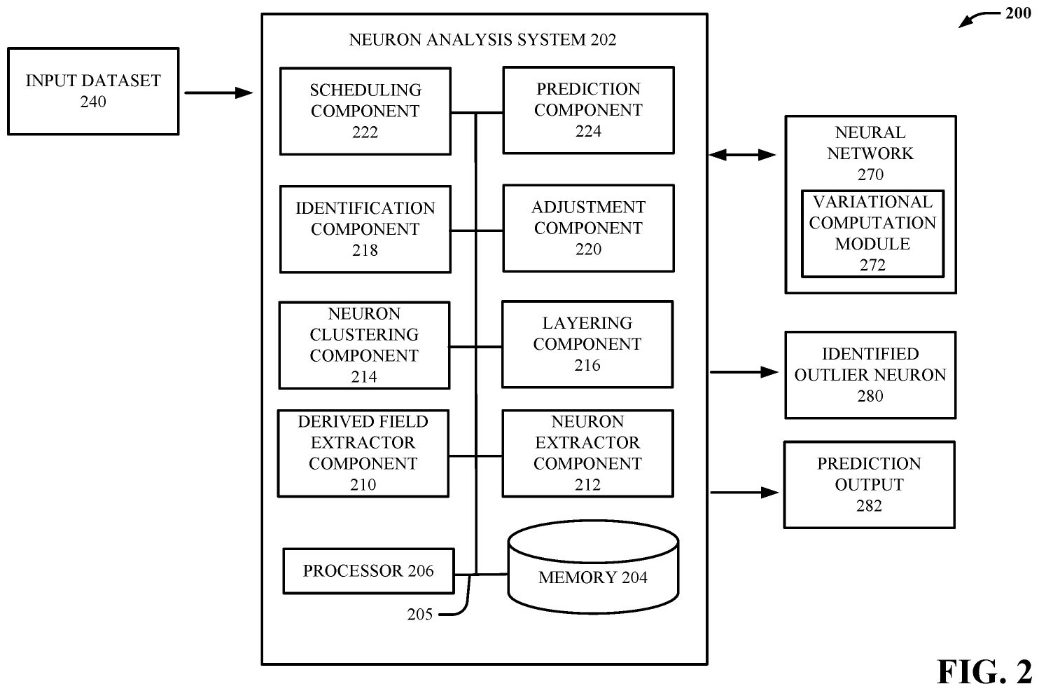

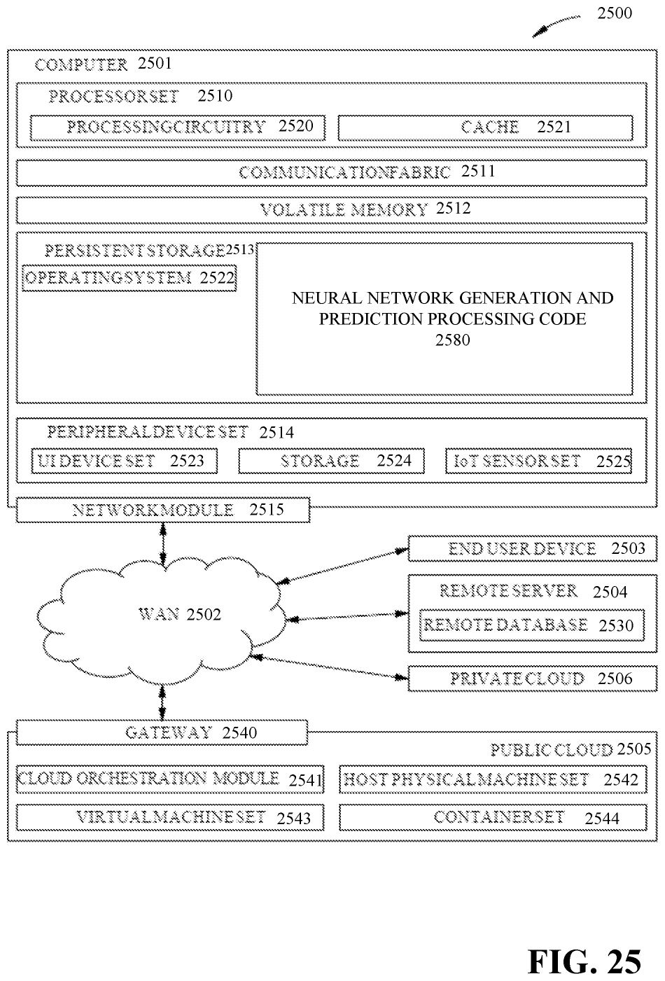

For example, in one or more embodiments, the non-limiting systems 100 and/or 200 illustrated at FIGS. 1 and 2, and/or systems thereof, can further comprise one or more computer and/or computing-based elements described herein with reference to a computing environment, such as the computing environment 2500 illustrated at FIG. 25. In one or more described embodiments, computer and/or computing-based elements can be used in connection with implementing one or more of the systems, devices, components and/or computer-implemented operations shown and/or described in connection with FIGS. 1 and/or 2 and/or with other figures described herein.

Turning now in particular to one or more figures, and first to FIG. 1, the figure illustrates a block diagram of an example, non-limiting system 100 that can facilitate a process to optimize performance of an operating neural network, in accordance with one or more embodiments described herein. That is, the non-limiting system 100 can facilitate a process to generate and employ a multi-layered variational computation module of a neural network (NN), which variational computation module can allow for operational speedup of the neural network and reduction of workload bottleneck (for workloads employing the NN) as compared to existing frameworks for neural network employment.

The non-limiting system 100 comprises a neuron analysis system 102. It is noted that the neuron analysis system 102 is only briefly detailed to provide but a lead-in to a more complex and/or more expansive neuron analysis system 202 as illustrated at FIG. 2. That is, further detail regarding processes that can be performed by one or more embodiments described herein will be provided below relative to the non-limiting system 200 of FIG. 2.

Still referring to FIG. 1, the neuron analysis system 102 can comprise at least a memory 104, bus 105, processor 106, identification component 118, adjustment component 120 and scheduling component 122. Using these components, the neuron analysis system 102 can adjust a generated variational computation module 172 of a neural network 170. The adjustment can, among other processes, comprise at least determination and assignment of outlier neurons, along with determination of subsequent cross-layer functionality for the virtual computation module 172.

The identification component 118 generally can, employing the multi-layered virtual computation module (VCM) 172 of looped neurons, identify a first neuron of a first cluster of a first layer of the looped neurons as being an outlier neuron. In one or more embodiments, this process can be performed during operation of the VCM.

The adjustment component 120 generally can reassign the outlier neuron from the first cluster to a second cluster of the first layer. In one or more embodiments, this process can be performed during operation of the VCM.

The scheduling component 122 generally can based on a dependency among layers of the resulting adjusted multi-layered virtual computation module, including the first layer, adjust a cross-layer functionality of the looped neurons for a workload. In one or more embodiments, this process can be performed during operation of the VCM, and thus the workload can be a workload currently being performed by the VCM.

The identification component 118, adjustment component 120 and scheduling component 122 can be operatively coupled to a processor 106 which can be operatively coupled to a memory 104. The bus 105 can provide for the operative coupling. The processor 106 can facilitate execution of the identification component 118, adjustment component 120 and scheduling component 122. The identification component 118, adjustment component 120 and scheduling component 122 can be stored at the memory 104.

In general, the non-limiting system 100 can employ any suitable method of communication (e.g., electronic, communicative, internet, infrared, fiber, etc.) to provide communication between the neuron analysis system 102 and the neural network 170.

Turning next to FIG. 2, a non-limiting system 200 is illustrated that can comprise a neuron analysis system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the neuron analysis system 202 can facilitate a process to train a variational quantum self-organizing map, in accordance with one or more embodiments described herein. That is, the non-limiting system 100 can facilitate a process to optimize performance of an operating neural network, in accordance with one or more embodiments described herein. That is, the non-limiting system 200 can facilitate a process to generate and employ a multi-layered variational computation module of a neural network (NN), which variational computation module can allow for operational speedup of the neural network and reduction of workload bottleneck (for workloads employing the NN) as compared to existing frameworks for neural network employment.

One or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The neuron analysis system 202 can be associated with, such as accessible via, a cloud computing environment.

The neuron analysis system 202 can comprise a plurality of components. The components can comprise a memory 204, processor 206, bus 205, derived field extractor component 210, neuron extractor component 212, neuron clustering component 214, layering component 216, identification component 218, adjustment component 220, scheduling component 222 and prediction component 224. Using these components, the neuron analysis system 202 can perform the generation and subsequent inference stage use of a multi-layered variational computation module 272 of a neural network 270.

Discussion next turns briefly to the processor 206, memory 204 and bus 205 of the neuron analysis system 202. For example, in one or more embodiments, the neuron analysis system 202 can comprise the processor 206 (e.g., computer processing unit, microprocessor, classical processor, quantum processor and/or like processor). In one or more embodiments, a component associated with neuron analysis system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the derived field extractor component 210, neuron extractor component 212, neuron clustering component 214, layering component 216, identification component 218, adjustment component 220, scheduling component 222 and prediction component 224.

In one or more embodiments, the neuron analysis system 202 can comprise the computer-readable memory 204 that can be operably connected to the processor 206. The memory 204 can store computer-executable instructions that, upon execution by the processor 206, can cause the processor 206 and/or one or more other components of the neuron analysis system 202 (e.g., derived field extractor component 210, neuron extractor component 212, neuron clustering component 214, layering component 216, identification component 218, adjustment component 220, scheduling component 222 and prediction component 224) to perform one or more actions. In one or more embodiments, the memory 204 can store computer-executable components (e.g., derived field extractor component 210, neuron extractor component 212, neuron clustering component 214, layering component 216, identification component 218, adjustment component 220, scheduling component 222 and prediction component 224).

The neuron analysis system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the neuron analysis system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the neuron analysis system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the neuron analysis system 202, the neural network 270 and the quantum system 401.

In addition to the processor 206 and/or memory 204 described above, the neuron analysis system 202 can comprise one or more computer and/or machine readable, writable and/or executable components and/or instructions that, when executed by processor 206, can provide performance of one or more operations defined by such component and/or instruction.

Turning now to the additional components of the neuron analysis system 202 (e.g., derived field extractor component 210, neuron extractor component 212, neuron clustering component 214, layering component 216, identification component 218, adjustment component 220, scheduling component 222 and prediction component 224), generally, the neuron analysis system 202 can

By generating and employing the adjusted variational computation module of the neural network 270, the one or more embodiments described herein can improve neural network scoring performance. That is, through the layering and adjustment of cluster of layers, based on reassigning of neurons being outliers to their initial clusters, speed of processing of the neural network 270 can be increased, therefore optimizing the performance of the neural network 270. This performance can be optimized in real-time (e.g., during operation of the neural network for one or more workloads using the looped neurons of the neural network 270 to provide one or more prediction results).

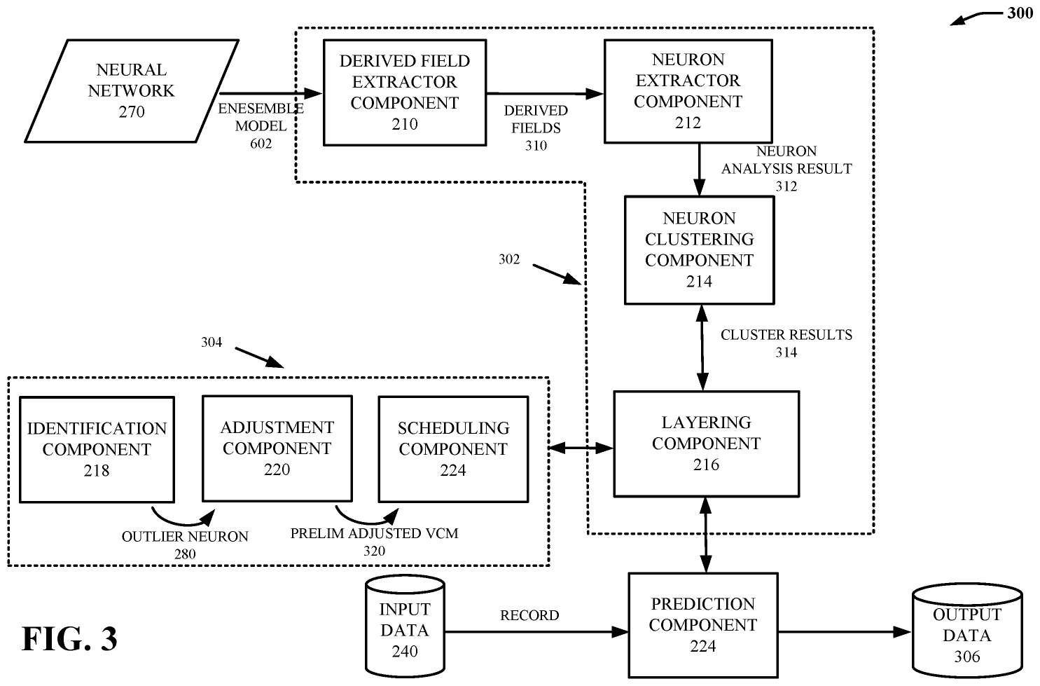

Discussion next turns to FIG. 3, along with FIG. 2, and to the first set of processes 302 of the schematic 300. The first set of processes 302 can together enable generation of the multi-layered, variational computation module 272.

Turning first to the derived filed extractor (DFE) component 210, the derived field extractor component 210 can generally classify derived fields corresponding to the looped neurons of the neural network 270 as one of the set of a plurality of processes 302 that together enable generation of the multi-layered, variational computation module 272. The DFE component 210 can obtain information related to the neural network 270, such as field information relevant to the looped neurons of the neural network 270, through communication with the neural network 270 by any suitable means. In one or more embodiments, the field information can comprise field types of target type, such as string, real or integer.

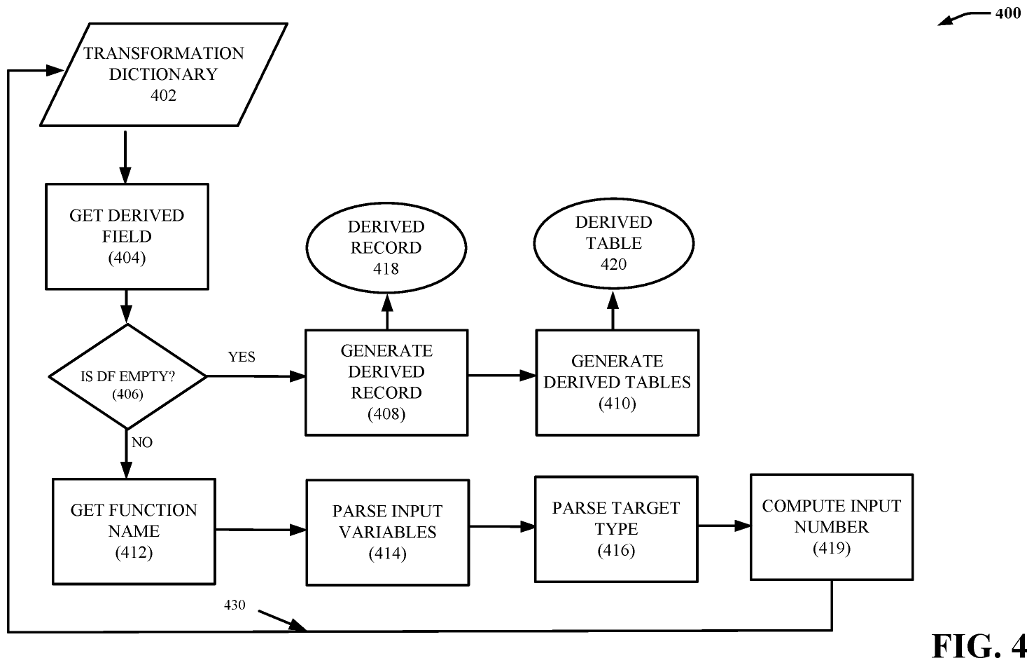

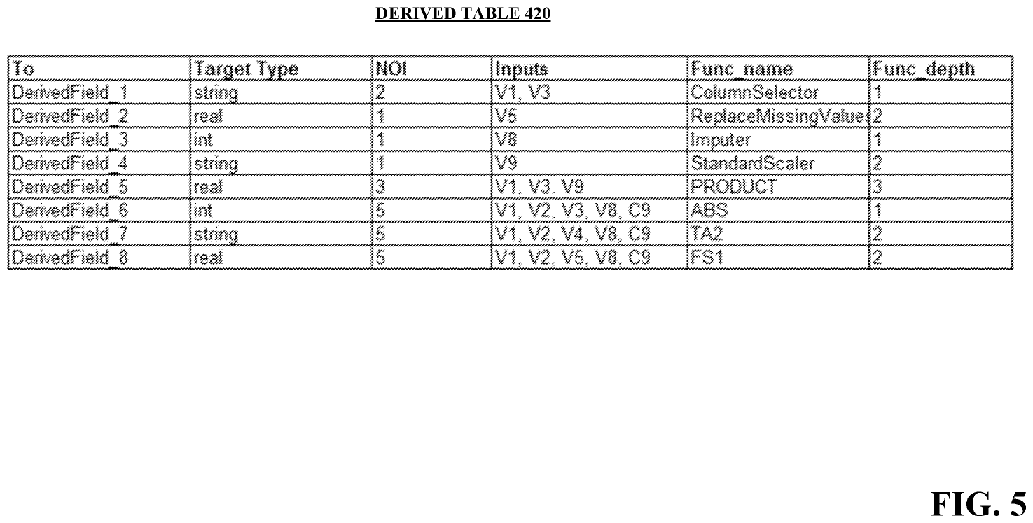

Turning to FIGS. 4 and 5, one or more processes that can be performed by the DFE component 210 are illustrated. FIG. 4 provides a schematic 400 of a set of processes for generating a derived fields table 420, an example of which is illustrated at FIG. 5.

The processes illustrated at FIG. 4 can be performed a plurality of times (e.g., via loop portion 430) to obtain a plurality of derived fields 310 for the derived fields table 420. The processes can comprise getting (e.g., identifying) a derived field 310 at step 404 from a transformation dictionary 402. The transformation dictionary 402 can be comprised by and/or external to the neuron analysis system 202. Any suitable method of communication between the transformation dictionary 402 and the neuron analysis system 202 can be employed.

Decision step 406 can comprise determining if the obtained derived field 310 is empty. As used herein, a derived field or neuron is empty if the derived field or neuron has no remaining connections. If the derived field is empty, the processes can proceed to step 408 of generating a derived record 418 and then to step 410 of generated a derived fields table 420 based on the derived record 418. Indeed, after the plurality of performances of the schematic 400 for a plurality of derived fields, the derived fields table 420 will be based on a plurality of derived records 418.

On the other hand, if the obtained derived filed is not empty, the schematic 400 can proceed to step 412 of getting a function name, step 414 of parsing input variables, step 416 of parsing target type, and step 418 of computing a number of inputs (NOI) for the current derived field being determined. Following completion of step 419, the loop portion 430 enables parsing of a plurality of derived fields.

The exemplary derived fields table 420 illustrated at FIG. 5 comprises definitions of target type, number of inputs, inputs, function name and function depth for each of the derived fields processed at FIG. 4 by the DFE component 212. As shown, target type can be a derived field type, such as string, real or int. the number of inputs is a total number of input variables for each derived field. The inputs then labeled as V1, C9, etc. The function name is that corresponding to the derived field, and the function depth is the number of recursions of that function.

Based on the derived fields table 420, and on classifications defined therein, the neuron extractor component 214 can generally assign the classifications to the looped neurons of the neural network 270.

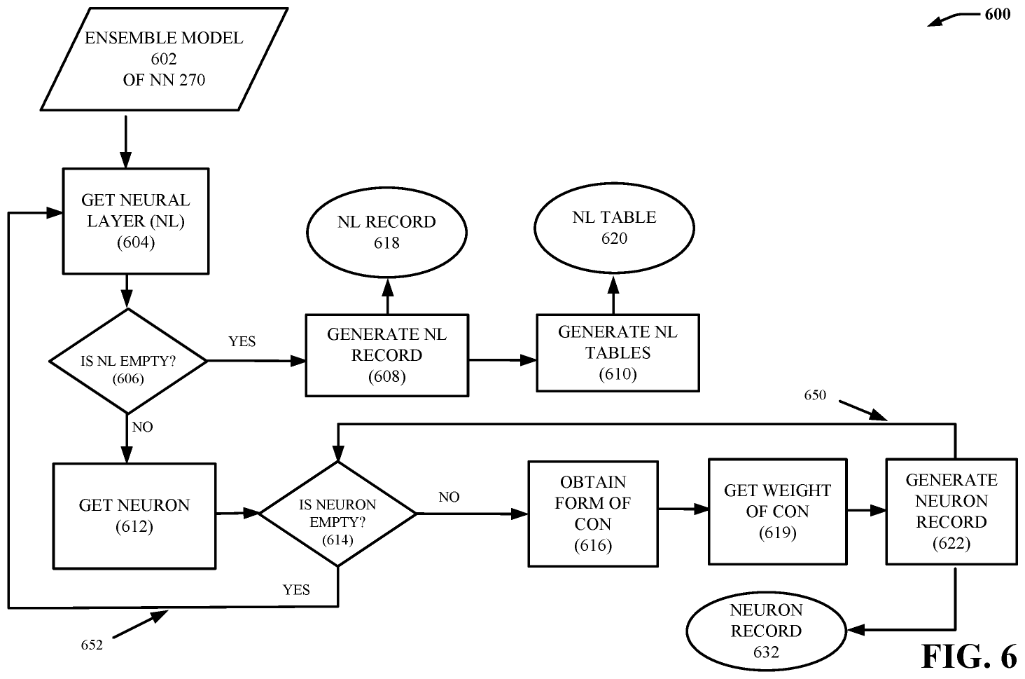

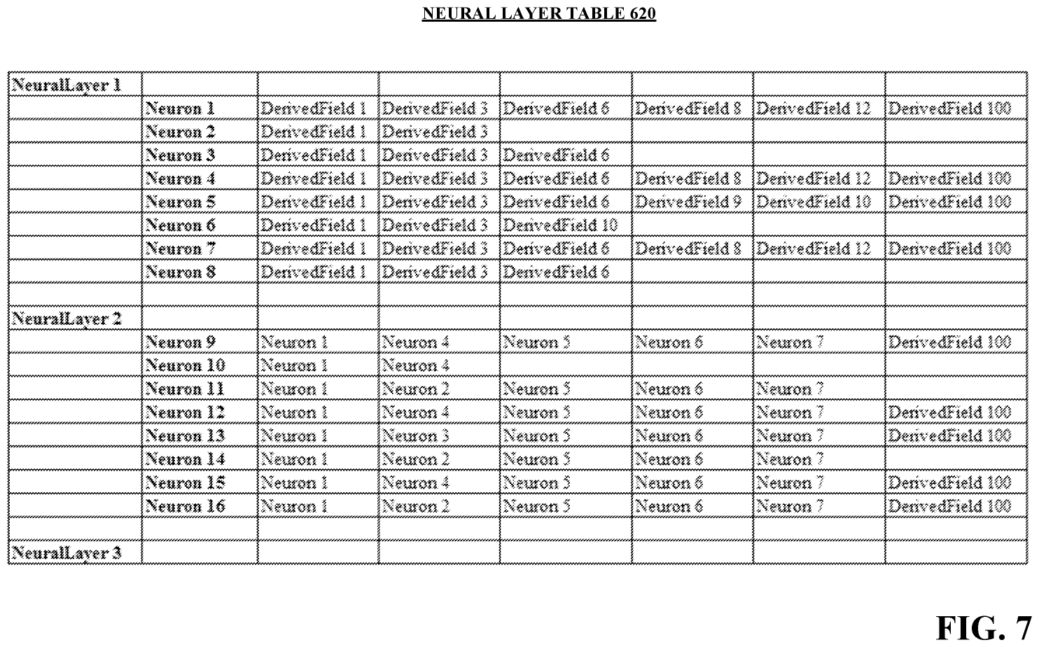

Turning to FIGS. 6 and 7, one or more processes that can be performed by the neuron extractor component 214 are illustrated. FIG. 6 provides a schematic 600 of a set of processes for generating a neural layer table 620, an example of which is illustrated at FIG. 7.

The processes illustrated at FIG. 6 can be performed a plurality of times (e.g., via loop portions 650 and 652) to obtain a plurality of neuron classification groups for a plurality of different neural layers of the neural network 270 (e.g., such as for an ensemble model 602 of the neural network 270). The processes can comprise getting (e.g., identifying) a neural layer (NL) at step 604 from an ensemble model 602.

Decision step 606 can comprise determining if the obtained neural layer is empty. If the neural layer is empty, the processes can proceed to step 608 of generating a neural layer record 618 and then to step 610 of generated a neural layer table 620 based on the neural layer record 618. Indeed, after the plurality of performances of the schematic 600 for a plurality of neural layers, the neural layer table 620 will be based on a plurality of neural layer records 618.

On the other hand, if the obtained neural layer is not empty, the schematic 600 can proceed to step 612 of getting (e.g., identifying) a neuron of the neuron layer, and then to decision step 614 of determining if the neuron is empty. As used herein, if a derived field or neuron is empty, then the derived field or neuron has no remaining connections. If the neuron is empty, the schematic 600 can proceed via the loop portion 652 to step 604 for getting another neural layer. If the neuron is not empty, the schematic can next proceed to the processes of step 616 of obtaining a form of a connection, step 619 of getting a weight of a connection and step 622 of generating a neuron record 632. Subsequent to step 622, the schematic 600 can proceed back to decision step 614.

For example, an exemplary connection can comprise: <Con from=“0”weight=“0.904057”/>, <Neuron id=“12”>, etc.

The exemplary neural layer table 620 illustrated at FIG. 7 defines the derived fields (e.g., defining the classifications) that correspond to neurons of the looped neurons of the neural network 270. Each neural layer at the neural layer table 620 can comprise one or more neurons. Each neuron can comprise one or more classifications (e.g., correspond to one or more derived fields). In one or more embodiments, those looped neurons can be distributed amongst a plurality of neural layers (e.g., 1, 2, 3, etc.) of the neural network 270.

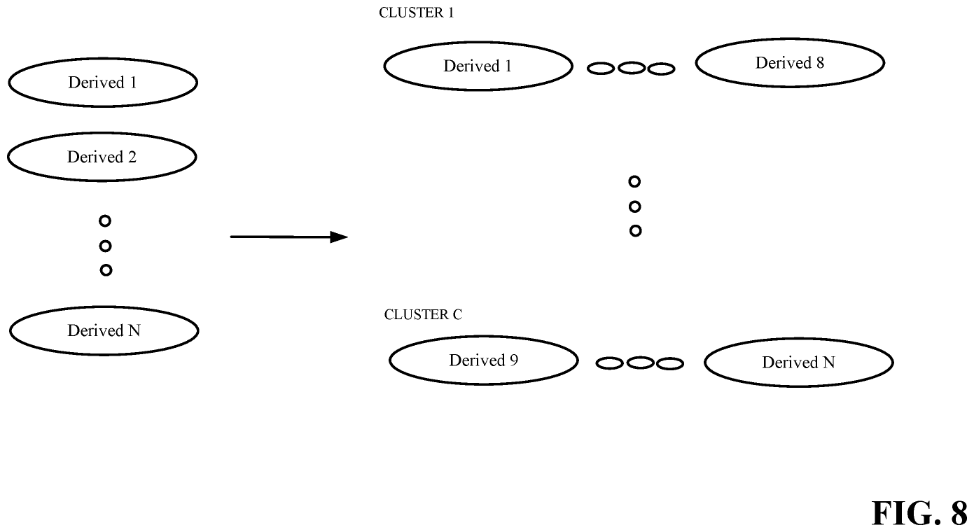

Based on the output (e.g., a neuron analysis result 312 based on the neural layer table 620) of the neuron extractor component 212, the neuron clustering component 214 can generally group the looped neurons into one or more clusters, labeled as clusters 1 to C at FIG. 8, based on the derived fields 1 to N, where N is the total number of derived fields of each neural layer.

FIG. 8 illustrates an initial clustering step of generating clusters 1 to C for a neural layer 1 of the ensemble model 602. As illustrated at FIG. 8, a plurality, such as all, derived fields corresponding to the neurons of the neural layer 1 can be grouped into the clusters 1 to C, where the number of total clusters of each neural layer is C. As shown at FIG. 8, the number of total derived fields

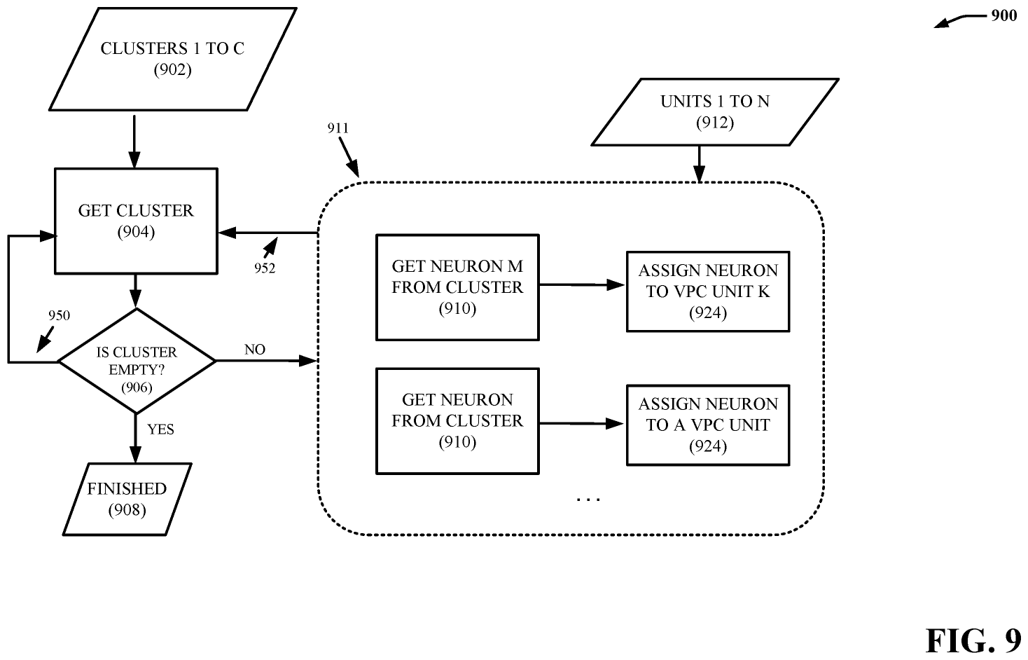

Based on an output of the neuron clustering component 214 (e.g., a cluster result 314), the layering component 216 can generally define and/or generate the one or more neural layers of a multi-layered virtual computation module 272. For example, turning to FIG. 9, the schematic 900 illustrates one or more processes that can be performed to assign the cluster results 314 to virtual parallel computation units of a virtual computation module 272, thereby enabling generation and/or definition of the virtual computation module 272. This assignment, performed by the layering component 216 can result in separation of the neurons of the neural layers (e.g., layers) of the neural network into virtual parallel computation units (VPC) 1 to N, such as where neurons of one cluster cannot all be assigned to a same VPC unit. Accordingly, the separation can result in separation of neurons of different clusters into different VPC units. As such, any neuron can correspond both to a cluster and to a VPC unit. That is, the assignment can comprise looping neurons from each cluster and assigning them, one cluster at a time, to the virtual parallel computation units 1 to N, where the number of total virtual parallel computation units is N.

In one or more embodiments, the separation can be based on equal or generally equal (e.g., up until no neurons remain) unit separation of neurons of a neural layer.

In one or more embodiments, the separation can comprise separating same labeled neurons into different virtual parallel computation units than one another.

Generally, this separation performed by the layering component 216 can comprise looping of neurons from a first cluster and assigning the neurons from the first cluster to units 1 to N of the VCM 272, wherein N is the Nth neuron. The separation performed subsequently after the first cluster can comprise looping of neurons from a second cluster and assigning the neurons from the second cluster to units K to K-1 of the VCM 272, where K is the Kth parallel unit from step 1. The separation performed subsequently after the second cluster can comprise repeating these steps for all clusters of each neural layer until the clusters are empty.

Put another way, this separation process can provide allocation of all neurons to different parallel units, which can be merely a traversal process including allocation of neurons to parallel units one by one.

More particularly, for each neural layer of the neural network 270/ensemble model 602, the processes of the schematic 900 can comprise, via the layering component 216, getting (e.g., identifying) a cluster at step 904 and determining, at step 906, whether the cluster is empty. If the cluster is empty, the processing of that cluster is complete and processing can proceed via loop 950 to step 904 to obtain another cluster, such as until no clusters remain of the clusters 1 to C of the plurality of layers of the ensemble model 602/neural network 270.

If the cluster is not empty, the schematic 900 can proceed to sub-group 911. At sub-group 911, the sub-step 910 can comprise getting (e.g., identifying) a neuron (e.g., an Mth neuron) of the cluster being analyzed. Sub-step 924 can comprise assigning the neuron can be assigned to a VPC unit, and subsequently, the schematic 900 can proceed via loop 950 back to step 904 to obtain another cluster for analysis.

If the cluster is empty, the schematic 900 can proceed to the end at step 908.

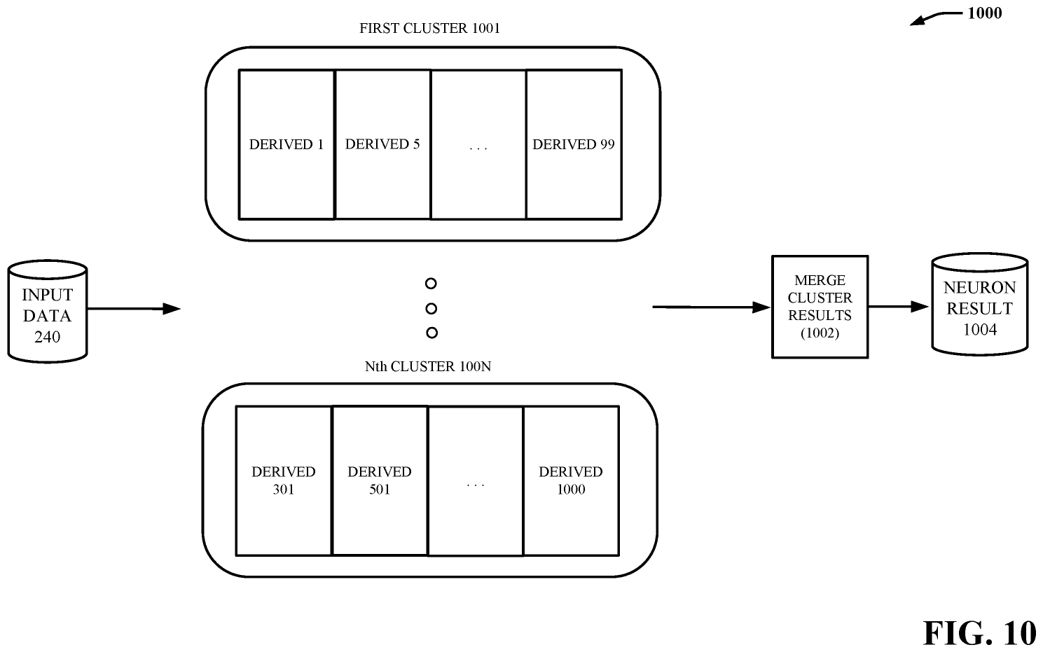

Turning to FIG. 10, schematic 1000 illustrates a result of the processes performed by the layering component 216 relative to FIG. 9. That is, the first layer of the VCM 272 can be operated including 1 to N clusters, each corresponding to particular sets of derived fields 310. Based on initial operation of this first layer of the VCM 272 during a test phase (or during a post-release phase), post-VPC generation test input data 240 can be input to the first layer of the VCM 272, such as by the prediction component 224, results of the different clusters can be merged (e.g., by the prediction component 224 and/or the VCM 272 at step 1002), and a neuron result 1004 can be output (e.g., by the prediction component 224 and/or the VCM 272) as a result of the merging of the results of the first layer of the VCM 272.

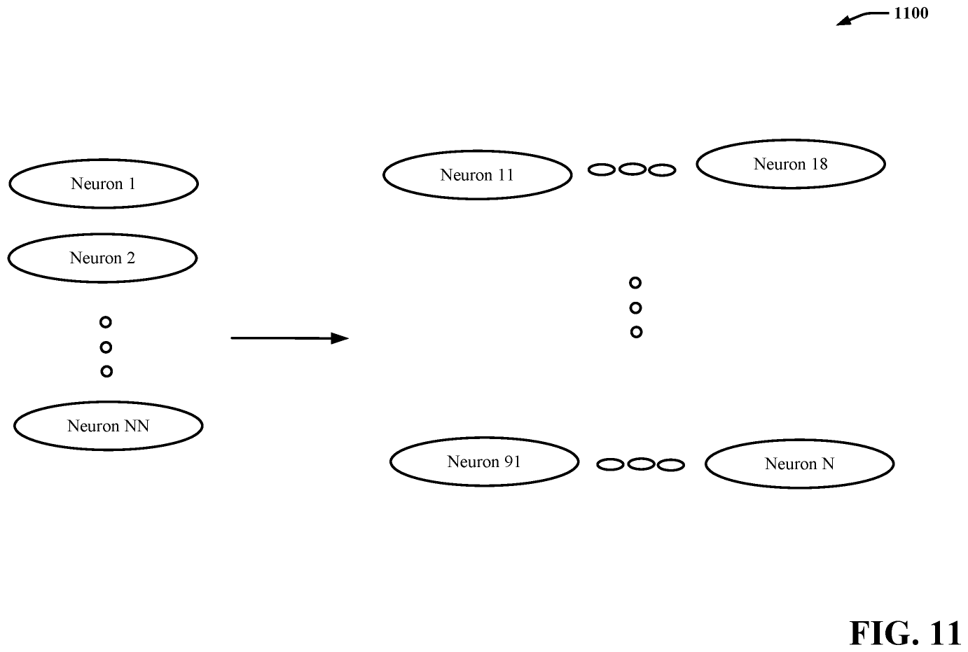

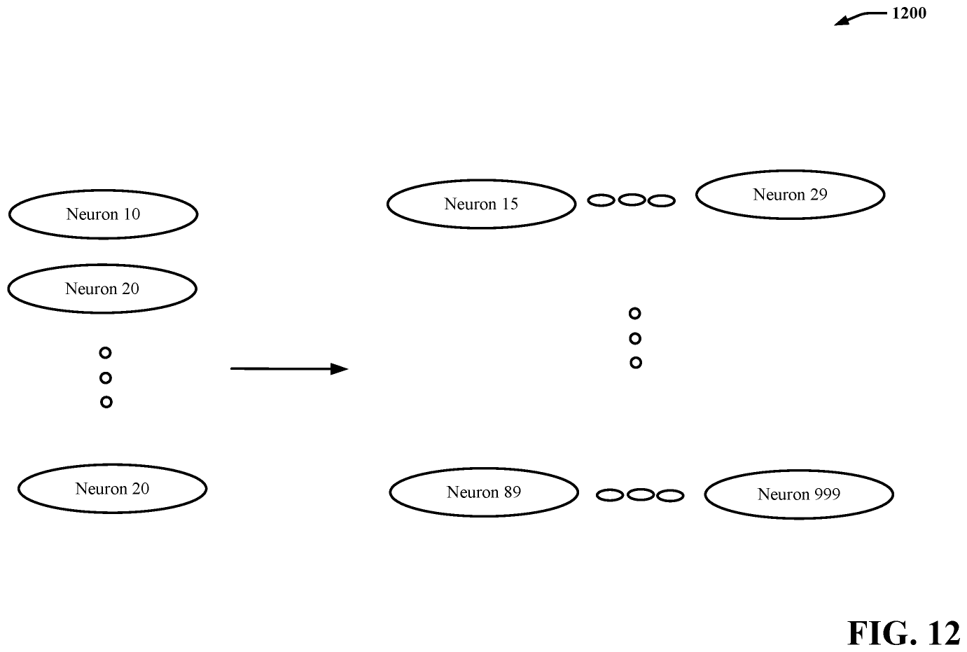

Turning next to FIG. 11, additional clustering, which can be performed by the clustering component 214, for a second neural layer of the neural network 270, is illustrated. At FIG. 12, additional clustering, which can be performed by the clustering component 214, for an Nth neural layer of the neural network 270, is illustrated.

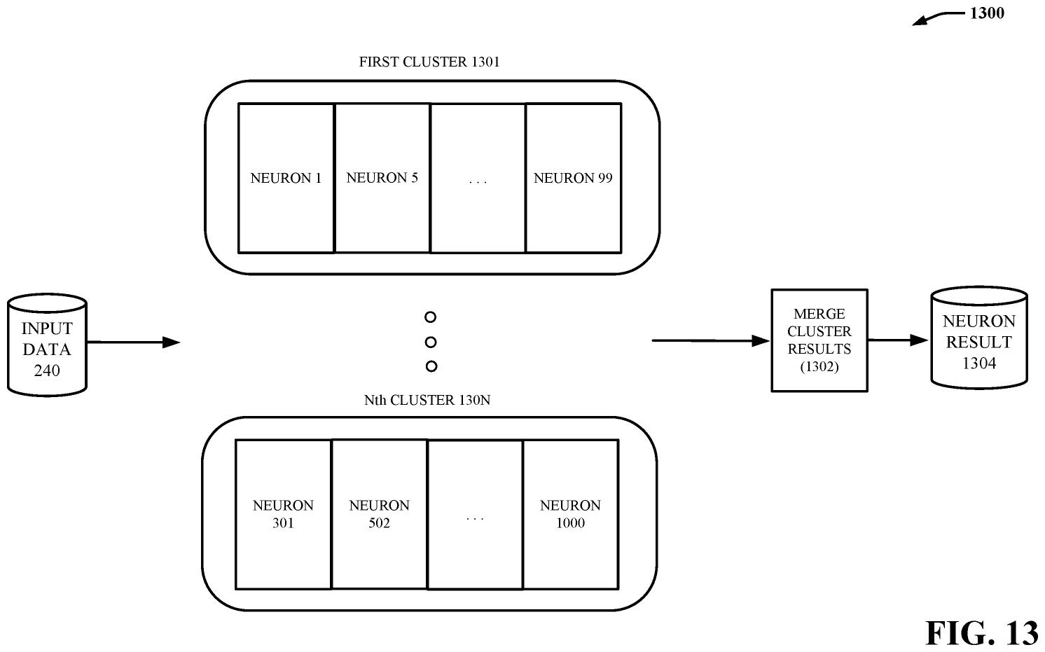

Accordingly, turning to FIG. 13, schematic 1300 illustrates a result of the processes performed by the layering component 216 relative to FIG. 9. That is, the Nth layer of the VCM 272 can be operated including 1 to N clusters, each corresponding to particular sets of neurons. Based on initial operation of this first layer of the VCM 272 during a test phase, post-VPC generation, test input data 240 can be input to the first layer of the VCM 272, such as by the prediction component 224, results of the different clusters can be merged (e.g., by the prediction component 224 and/or the VCM 272 at step 1302), and a neuron result 1304 can be output (e.g., by the prediction component 224 and/or the VCM 272) as a result of the merging of the results for the Nth layer of the VCM 272.

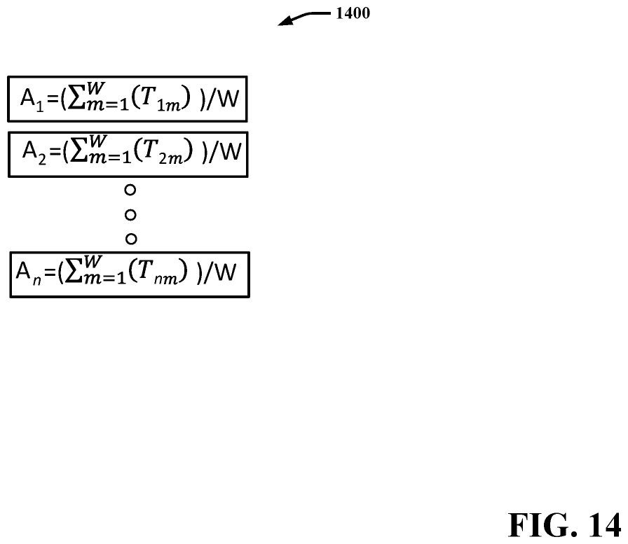

Next, with reference to FIGS. 14 to 22, based on the clustering and layer defining performed by the neuron clustering component 214 and the layering component 216, one or more processes of a second set 304 (FIG. 3) of processes can be performed by the identification component 218, adjustment component 220 and/or scheduling component 222.

In one or more embodiments, the steps of the second set 304 can be performed in real-time (e.g., rapidly during operation of the VCM 272).

Generally, employing the VCM 272, such as an operating VCM 272, the identification component 218 can identify a first neuron of a first cluster of a first layer of the VCM 272 as being an outlier neuron 280. Referring to the schematic 1400 of FIG. 14, this determination can be based on an elapsed time analysis of an amount of time (Tnw) since a last record W for each neuron was output/registered. See, e.g., equations employed for each neuron at FIG. 14.

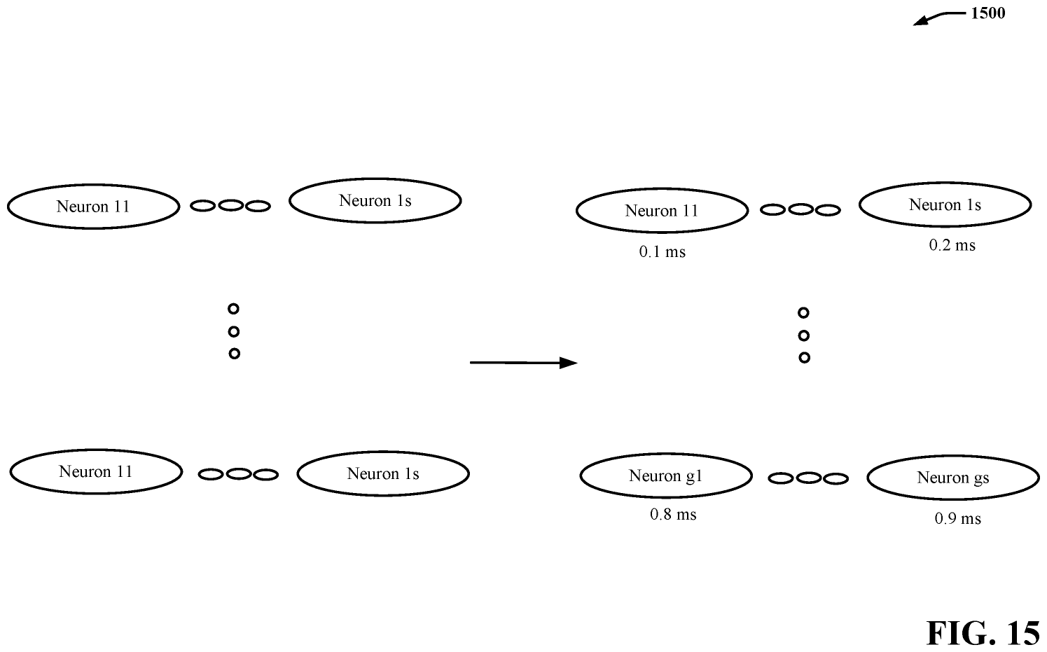

Turning to schematic 1500 of FIG. 15, for each neuron, an average time of W and W history points An can be generated by the identification component 218. As illustrated at FIG. 15, the average times for exemplary neurons of exemplary clusters of the VCM 272 are listed as 0.1 ms, 0.2 ms, 0.8 ms and 0.9 ms.

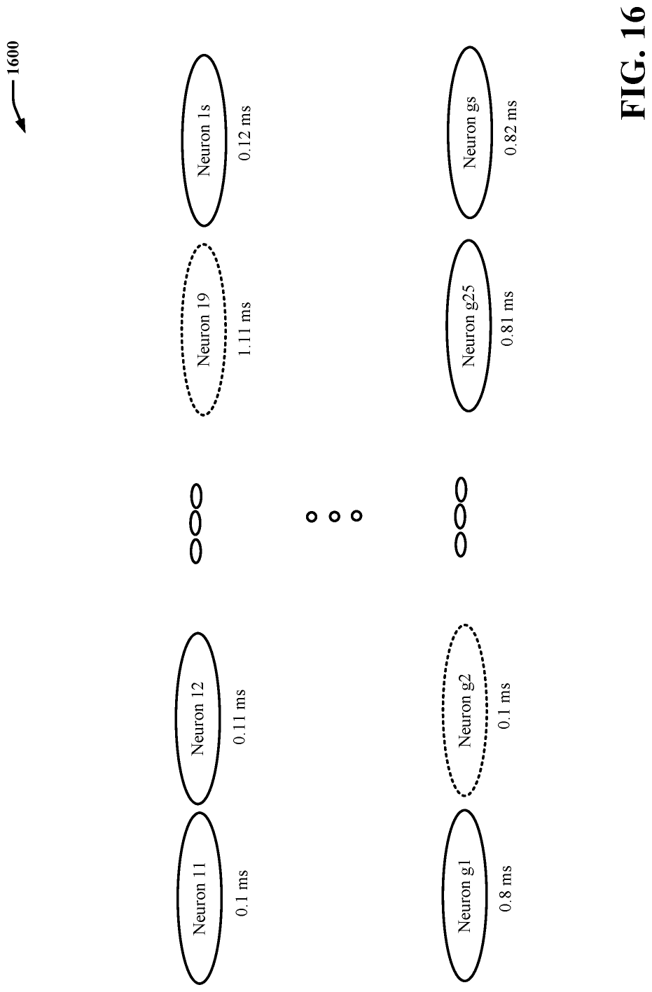

Turning to schematic 1600 of FIG. 16, based on the average time (A₁, A₂ to A_{w}) for each neuron, one or more outlier neurons for one or more clusters of the VCM 272 units (such as at least one outlier neuron for each cluster of the VCM 272 units) can be determined. The determination can be based on statistical difference between the average times of the neurons of a cluster, or based on any other suitable metric. As illustrated at FIG. 16, the outlier neurons g2 and 19 are identified by dashed line borders. For example, the neuron g2 is statistically faster than the other neurons of the respective cluster. Also, the neuron 19 is statistically slower than the other neurons of the other respective cluster. It is noted that here, and at FIG. 16, “s” is the serial number of the neuron in a certain cluster, and “g” is the serial number of the certain cluster. For example, the 8^{th} neuron in the 5^{th} cluster would be N58 or neuron 58.

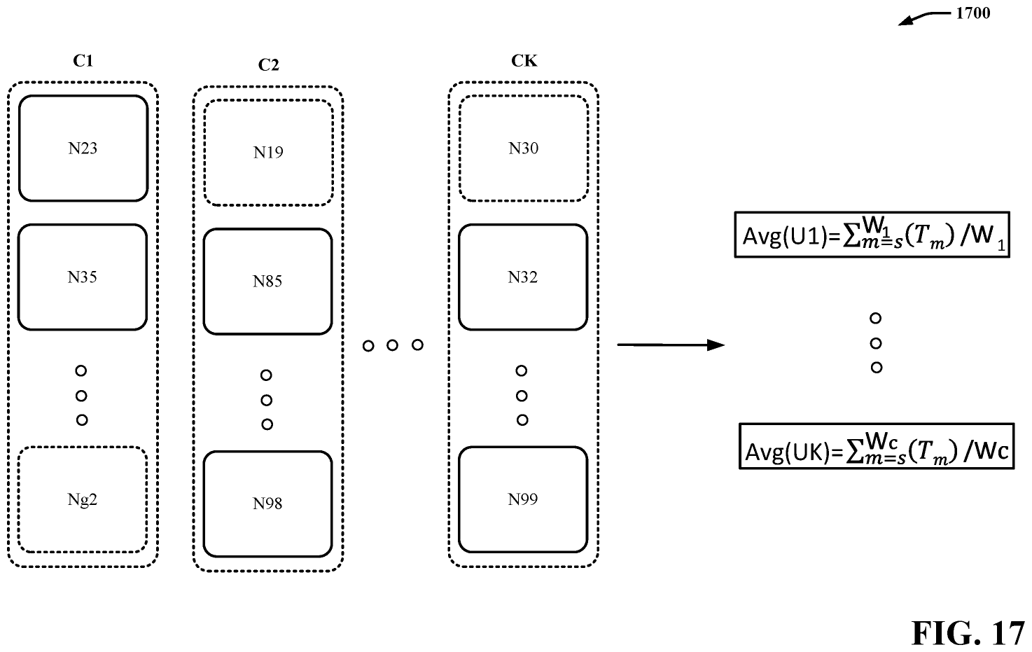

Turning to FIG. 17, subsequent to identification of the outlier neurons 282, the identification component can, for each cluster, determine revised averaged elapsed time (Avg(U1) to Avg(UK) of the other neurons (e.g., eliminating the average time for the outlier neurons) for each cluster. As illustrated at schematic 1700, the equations employed are shown, where s is the start index of a model in a cluster and Wc is a number of models in a cluster.

That is, generally, for a plurality of clusters of the first layer and of additional layers of the layers of the multi-layered virtual computation module, other than the first cluster, the identification component 218 can identify an additional outlier neuron for each cluster of the plurality of clusters of the first layer and of the additional layers.

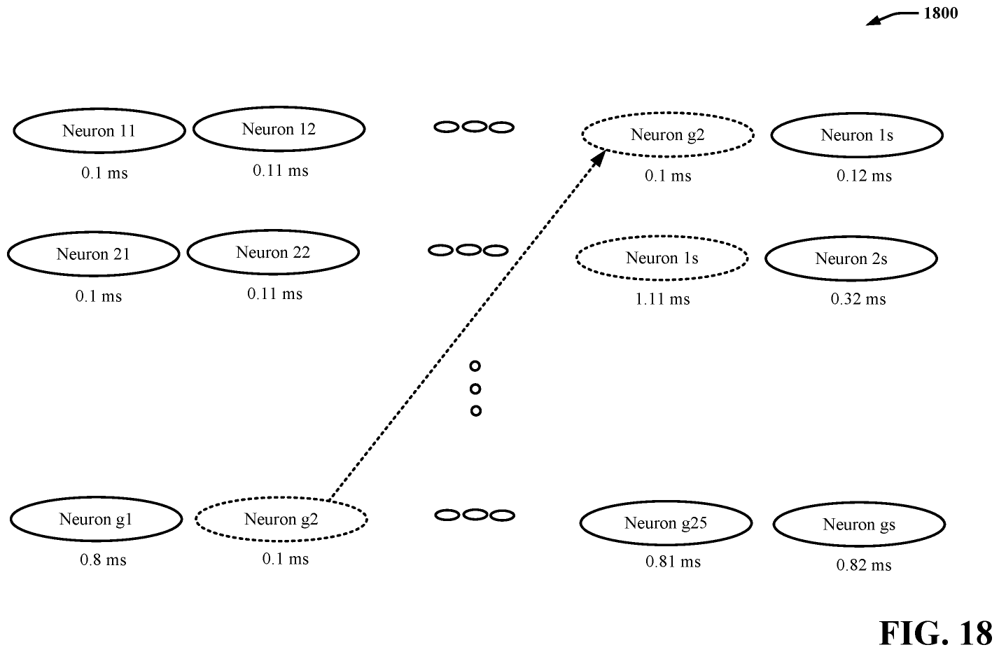

Turning to schematic 1800 of FIG. 18, the adjustment component 220 can reassign an outlier neuron from a first cluster to a second cluster, such as of the same layer (e.g., VPC unit) or different layer (e.g., VPC unit) of the VCM 272. For example, this reassignment can be facilitated based on a metric of the second cluster, such as a mean of the elapsed times of the neurons of the second cluster. Accordingly, one or more neuron results can be reassigned to different clusters.

That is, generally, for the plurality of clusters of the first layer and of the additional layers, the adjustment component 220 can reassign each outlier neuron of the additional outlier neurons to a different cluster of a same layer, of the layers, comprising the cluster initially having the outlier neuron.

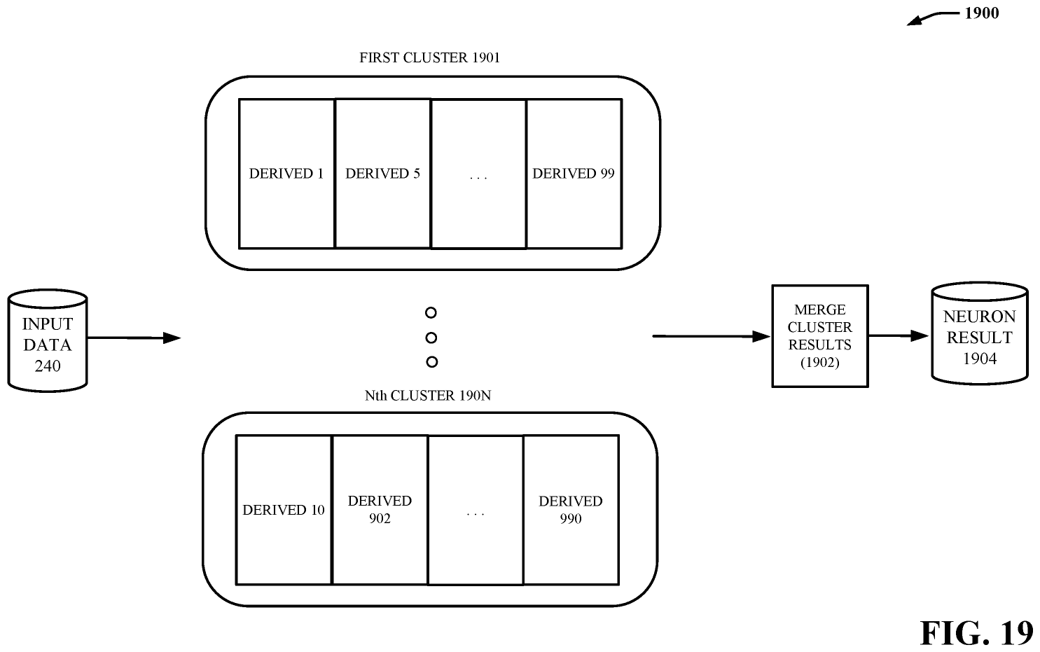

Turning to schematic 1900 of FIG. 19, illustrated is a result of the processes performed by the identification component 218 and the adjustment component 220. That is, the Nth layer of the VCM 272 can be operated including 1 to N clusters, each corresponding to particular sets of derived fields 310. Based on initial operation of this first layer of the VCM 272 during a test phase, post-VPC generation, test input data 240 can be input to the Nth layer of the VCM 272, such as by the prediction component 224, results of the different clusters can be merged (e.g., by the prediction component 224 and/or the VCM 272 at step 1902), and a neuron result 1904 can be output (e.g., by the prediction component 224 and/or the VCM 272) as a result of the merging of the results for the Nth layer of the VCM 272.

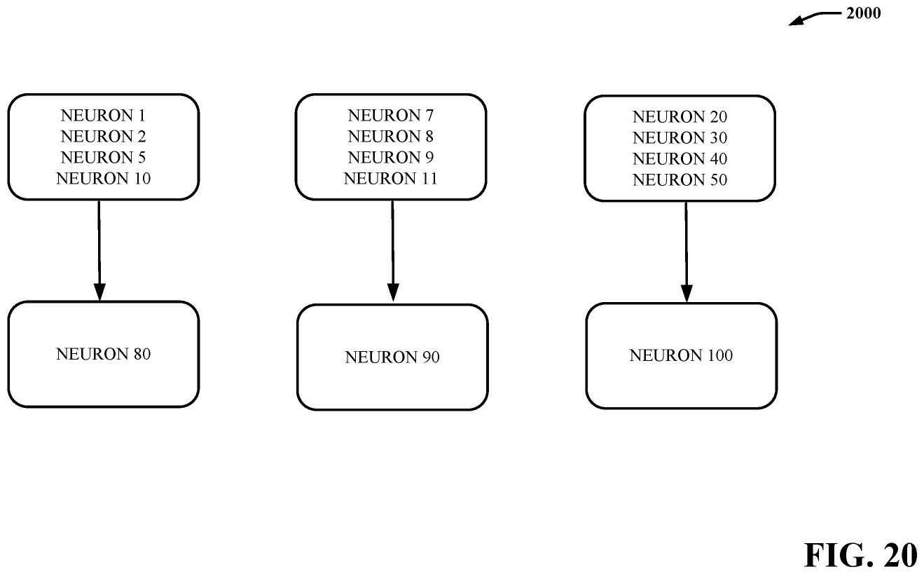

As a result of the reassignment of the outlier neurons, turning to FIG. 20, the scheduling component 222 can regenerate cluster results (e.g., 314) of the respective VCM 272 units. For example, based on a preliminary adjusted variational computation module 320 resulting from the operations of the identification component 218 and the adjustment component 220, the scheduling component 222 can generally, based on a dependency among layers of the multi-layered virtual computation module 272, including the first layer, adjust a cross-layer functionality of the looped neurons, resulting in the adjusted variational computation module 272.

Regarding cross-layer scheduling, a main consideration is a dependency relationship of neurons, which means that neurons with more dependencies can be calculated first. For example, in a third layer, of neurons 10 and 11 that rely on the second layer, and of neurons 8 and 9 that do not rely on the second layer, neurons 10 and 11 can be calculated first.

For example, as illustrated at schematic 2000 for exemplary neurons of different VPC units of the VCM 272, operation of neuron 80 can be dependent on operation of neurons 1, 2, 5 and 10. At least one of neurons 1, 2, 5 and 10 can be at a different VPC unit than the neuron 80. As another example, operation of neuron 90 can be dependent on operation of neurons 7, 8, 9 and 11. At least one of neurons 7, 8, 9 and 11 can be at a different VPC unit than the neuron 90. As still another example, operation of neuron 100 can be dependent on operation of neurons 20, 30, 40 and 50. At least one of neurons 20, 30, 40 and 50 can be at a different VPC unit than the neuron 100.

In one or more embodiments such cross-layer functionality can be adjusted for a workload currently being performed by the preliminary adjusted multi-layered virtual computation module 320.

In one or more embodiments, a cross layer functionality can be adjustably varied, by the scheduling component 222, based on dependency relationship between neurons of different VPC units.

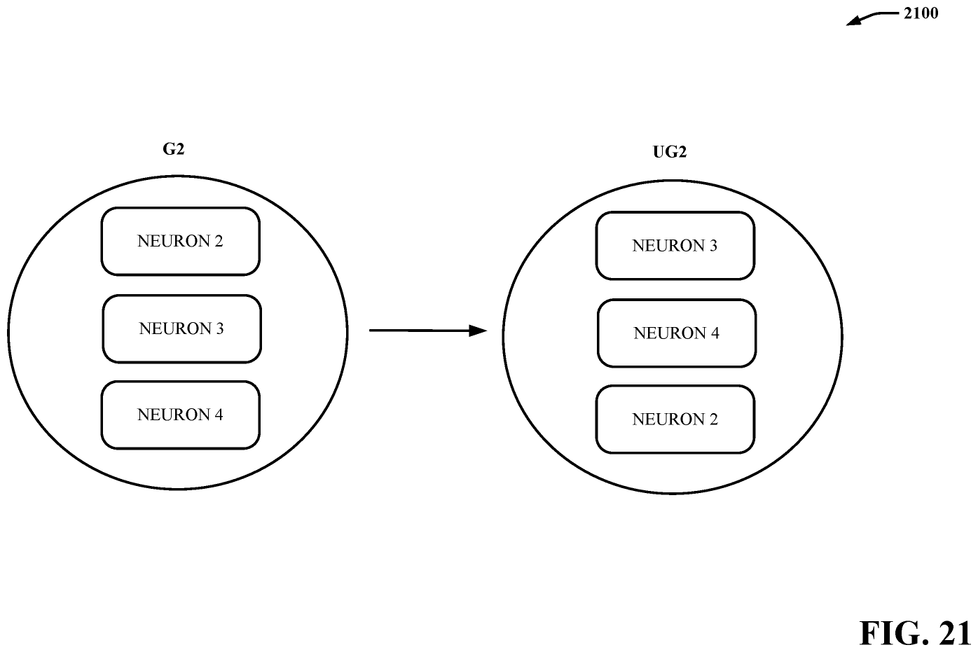

Turning next to FIG. 21, neuron automatic adjustment also can be performed by the scheduling component 222. For example, an order of operation of neurons of at least one cluster of the VCM 272 can be adjusted. That is, a neuron weight can be computed for each neuron of a cluster based on Equation 1. Based on the results of Equation 1, an order of neuron operation can be adjusted. Adjustment based on decreasing order of weights, increasing order of weights, or some other order of weights can be performed by the scheduling component 222.

Equation 1: W(u)=Σ0.5*D(u)+0.5*T(u)/T, where W(u) is the weight of the u-th neuron; D(u) is 0 if all inputs of the u-th neuron are not finished, otherwise 1; T(u) is the elapsed time of the u-th neuron; and T is total elapsed time of all neurons in the cluster. As used herein, W(u) is the weight of the u-th neuron, D(u) is 0 if all inputs of the u-th neuron are not finished, and otherwise 1, T(u) is the elapsed time of the u-th neuron, T is the total elapsed time of all neurons in the group, F(u) is the number of neurons using, and F is the remaining unfinished neuron quantity.

For example, at the schematic 2100 of FIG. 21, an order of neurons of cluster G2 (e.g., neuron 2, neuron 3, neuron 4) is changed for an updated cluster order UG2 (e.g., neuron 3, neuron 4, neuron 2). As used herein, G is a group, U is an update, and UG is an updated group.

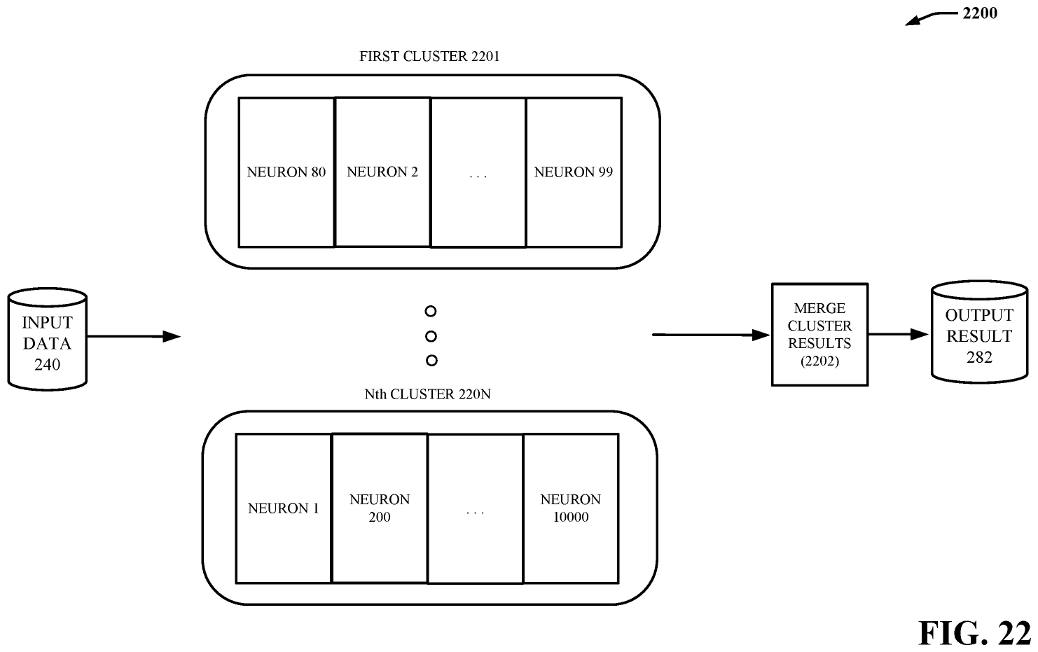

Finally, referring next to FIG. 22, based on the adjusted variational computation module 272 resulting from the performance of the processes of the second set 304 of processes (e.g., ultimately output by and/or made available by notice from the layering component 216), the prediction component 224 can generally generate a prediction (e.g., an output result 282 defined by output data 306) based on input data (e.g., input data or input data set 240) input into the adjusted multi-layered virtual computation module 272 by function of the prediction component 224. Each of the input data 240 and the output data 306 can have any suitable format.

In particular, illustrated at schematic 2200 of FIG. 22 is a result of the processes performed by the identification component 218, the adjustment component 220 and the scheduling component 222. That is, the Nth layer of the VCM 272 can be operated including 1 to N clusters, each corresponding to particular sets of neurons. Input data 240 can be input to the Nth layer of the VCM 272, such as by the prediction component 224, results of the different clusters can be merged (e.g., by the prediction component 224 and/or the VCM 272 at step 2202), and an output result 282 can be output (e.g., by the prediction component 224 and/or the VCM 272) as a result of the merging of the results for the Nth layer of the VCM 272.

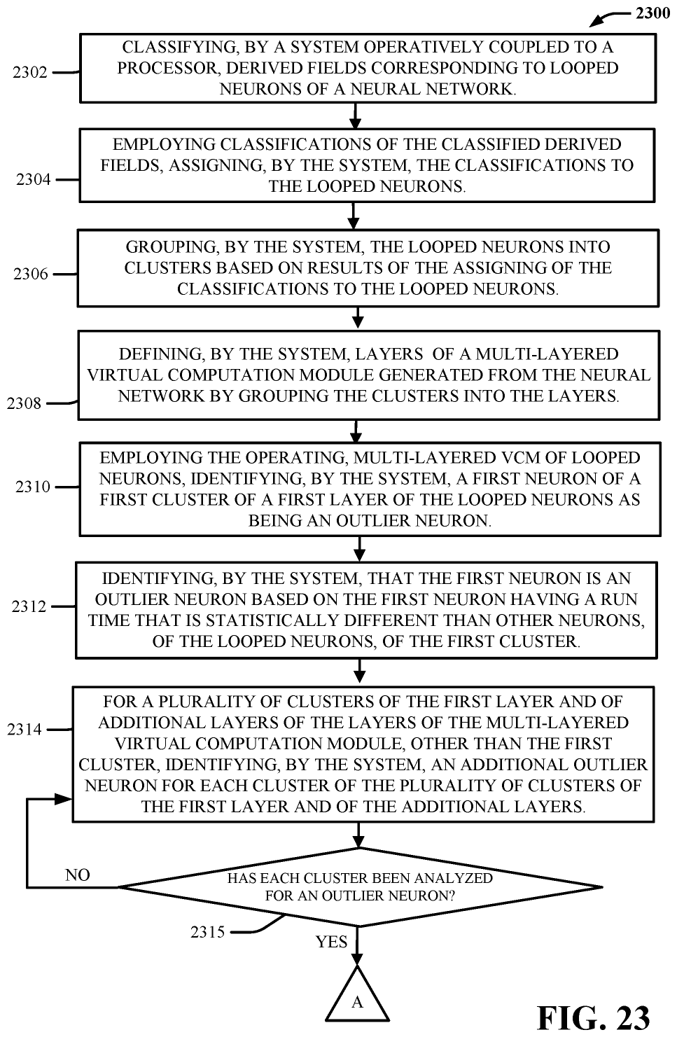

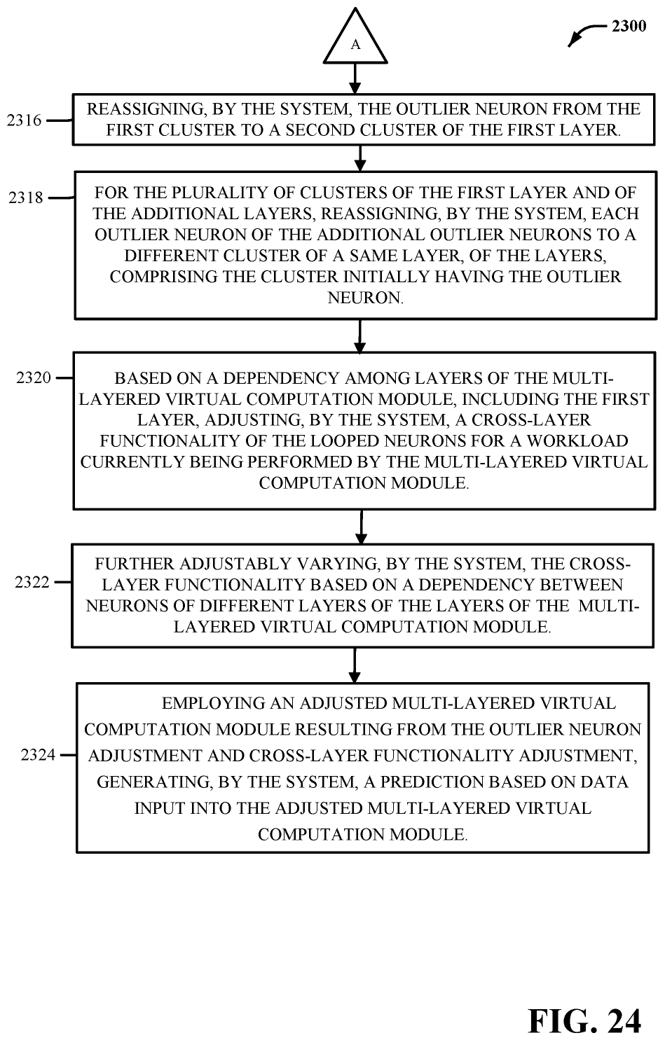

As a summary of the above-detailed steps that can be performed by the neuron analysis system 202, referring next to FIGS. 23 and 24, illustrated is a flow diagram of an example, non-limiting method 2300 that can provide a process to optimize performance of an operating neural network, in accordance with one or more embodiments described herein, such as the non-limiting system 200 of FIG. 2. While the non-limiting method 2300 is described relative to the non-limiting system 200 of FIG. 2, the non-limiting method 2300 can be applicable also to other systems described herein, such as the non-limiting system 100 of FIG. 1. Repetitive description of like elements and/or processes employed in respective embodiments is omitted for sake of brevity.

At 2302, the non-limiting method 2300 can comprise classifying, by a system operatively coupled to a processor (e.g., derived field extractor component 210), derived fields corresponding to looped neurons of a neural network (e.g., neural network 270).

At 2304, the non-limiting method 2300 can comprise employing classifications of the classified derived fields, assigning, by the system (e.g., neuron extractor component 214), the classifications to the looped neurons.

At 2306, the non-limiting method 2300 can comprise grouping, by the system (e.g., neuron clustering component 214), the looped neurons into clusters based on results of the assigning of the classifications to the looped neurons.

At 2308, the non-limiting method 2300 can comprise defining, by the system (e.g., layering component 216), layers (e.g., VPC units) of a multi-layered virtual computation module (e.g., VCM 272) generated from the neural network by grouping the clusters into the layers.

At 2310, the non-limiting method 2300 can comprise employing the operating, multi-layered VCM of looped neurons, identifying, by the system (e.g., identification component 218), a first neuron of a first cluster of a first layer of the looped neurons as being an outlier neuron (e.g., outlier neuron 280).

At 2312, the non-limiting method 2300 can comprise identifying, by the system (e.g., identification component 218), that the first neuron is an outlier neuron based on the first neuron having a run time that is statistically different than other neurons, of the looped neurons, of the first cluster.

At 2314, the non-limiting method 2300 can comprise, for a plurality of clusters of the first layer and of additional layers of the layers of the multi-layered virtual computation module, other than the first cluster, identifying, by the system (e.g., identification component 218), an additional outlier neuron for each cluster of the plurality of clusters of the first layer and of the additional layers.

At 2315, the non-limiting method 2300 can comprise determining, by the system (e.g., identification component 218) whether each cluster has been analyzed for an outlier neuron. If yes, the non-limiting method 2300 can proceed to step 2316. If no, the non-limiting method 2300 can proceed again to step 2314.

At 2316, the non-limiting method 2300 can comprise reassigning, by the system (e.g., adjustment component 220), the outlier neuron from the first cluster to a second cluster of the first layer.

At 2318, the non-limiting method 2300 can comprise, for the plurality of clusters of the first layer and of the additional layers, reassigning, by the system (e.g., adjustment component 220), each outlier neuron of the additional outlier neurons to a different cluster of a same layer, of the layers, comprising the cluster initially having the outlier neuron.

At 2320, the non-limiting method 2300 can comprise, based on a dependency among layers of the multi-layered virtual computation module, including the first layer, adjusting, by the system (e.g., scheduling component 222), a cross-layer functionality of the looped neurons for a workload currently being performed by the multi-layered virtual computation module.

At 2322, the non-limiting method 2300 can comprise further adjustably varying, by the system (e.g., scheduling component 222), the cross-layer functionality based on dependency between neurons of different layers of the multi-layered virtual computation module.

At 2324, the non-limiting method 2300 can comprise, employing an adjusted multi-layered virtual computation module resulting from the outlier neuron adjustment and cross-layer functionality adjustment, generating, by the system (e.g., prediction component 224), a prediction based on data input into the adjusted multi-layered virtual computation module.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, one or more systems, computer program products and/or computer-implemented methods described herein relate to a process to optimize performance of an operating neural network. A system can comprise a memory that stores computer executable components and a processor that executes the computer executable components, which can comprise an identification component that, employing an operating, multi-layered virtual computation module of looped neurons, identifies a first neuron of a first cluster of a first layer of the looped neurons as being an outlier neuron, an adjustment component that reassigns the outlier neuron from the first cluster to a second cluster of the first layer, and a scheduling component that, based on a dependency among layers of the multi-layered virtual computation module, including the first layer, adjusts a cross-layer functionality of the looped neurons for a workload currently being performed by the multi-layered virtual computation module.

A benefit of the one or more systems, computer program products and/or computer-implemented methods can be an ability to improve neural network scoring performance through the generation and adjustment of a multi-layered variational computation module of the neural network. That is, through the layering and adjustment of cluster of layers, based on reassigning of neurons being outliers to their initial clusters, speed of processing of the neural network can be increased, therefore optimizing the performance of the neural network. This performance can be optimized in real-time (e.g., during operation of the neural network for one or more workloads using the looped neurons of the neural network to provide one or more prediction results).

Another benefit of the one or more systems, computer program products and/or computer-implemented methods can be an ability to, based on adjustment of a multi-layered variational computation module of the neural network, avoid one or more bottlenecks of use of the neural network to process one or more workloads. That is, relative to single workloads, back-to-back workloads or workloads being parallelly-processed, the one or more embodiments described herein can perform real-time (e.g., rapid, during operation of the neural network) adjustment of neuron cluster association, and associated layer dependency analysis. As such, one or more neurons can be reassigned to clusters having run times that are statistically similar to one another, thus preventing a neuron that is an outlier of a cluster of neurons from impeding rapid processing by that cluster of neurons.

Still another benefit of the one or more systems, computer program products and/or computer-implemented methods can be an ability to, adjust cross layer functionality (e.g., functionality across layers of a variational computation module) based on a selected number of neurons to be employed for a workload and/or for another requirement (e.g., type of neurons, historical run time of neurons, etc.) associated with a workload.

Indeed, in view of the one or more embodiments described herein, a practical application of the one or more systems, computer-implemented methods and/or computer program products described herein can be the obtaining of in-process workload-based neural network speedup. That is, the one or more embodiments described herein can improve the performance of a neural network through use of a multi-layered, assignment adjustable, variational computation module of a neural network. In one or more embodiments, the adjustment can be performed separate from a workload and/or during processing of the workload or another workload (the another workload being unrelated to the adjustment). Such NN's can be useful in fields of finance, crime analysis, biology, chemistry, materials science, pharmacology and/or drug-delivery, without being limited thereto. Accordingly, the one or more embodiments described herein can provide useful and practical applications of computers, thus providing enhanced (e.g., improved and/or optimized) neural network adjustment resulting in enhanced data analysis and prediction output. Overall, such computerized tools can constitute a concrete and tangible technical improvement in the fields of artificial intelligence and neural networks.

Furthermore, one or more embodiments described herein can be employed in a real-world system based on the disclosed teachings. For example, one or more embodiments described herein can function with a neural network to adjust the neural network (e.g., optimize the neural network for increased speedup), where the neural network can be employed thereafter or in process of performance (e.g., in real time) for various inference actions relative to requested predictions.

Moreover, one or more embodiments described herein can be implemented in one or more domains to enable scaled prediction output and/or NN adjustment. Indeed, use of a system as described herein can be scalable, such as where plural workloads can be evaluated at a same time using a variational computation module generated by the one or more embodiments described herein. In one or more embodiments, one set of layers can be adjusted for one workload at least partially in parallel with adjustment of a different set of layers, of the same NN, for a different workload.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to variational computation module generation and adjustment, as compared to existing systems and/or techniques. Systems, computer-implemented methods and/or computer program products providing performance of these processes are of great utility in the fields of neural network predictions and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically interact with neurons of a neural network, generate layers of a neural network, and/or reassign neurons of a neural network as the one or more embodiments described herein can provide these processes. Moreover, neither can the human mind nor a human with pen and paper conduct such processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

A system, comprising: a memory that stores computer executable components; and a processor that executes the computer executable components stored in the memory, wherein the computer executable components comprise: an identification component that, employing an operating, multi-layered virtual computation module of looped neurons, identifies a first neuron of a first cluster of a first layer of the looped neurons as being an outlier neuron; an adjustment component that reassigns the outlier neuron from the first cluster to a second cluster of the first layer; and a scheduling component that, based on a dependency among layers of the multi-layered virtual computation module, including the first layer, adjusts a cross-layer functionality of the looped neurons for a workload currently being performed by the multi-layered virtual computation module.

The system of the previous paragraph, wherein the identifying, by the identification component, that the first neuron is an outlier neuron, is based on the first neuron having a run time that is statistically different than other neurons, of the looped neurons, of the first cluster.

The system of any previous paragraph, further comprising: a prediction component that, employing an adjusted multi-layered virtual computation module resulting from the adjustment performed by the scheduling component, generates a prediction based on data input into the adjusted multi-layered virtual computation module.

The system of any previous paragraph, wherein for a plurality of clusters of the first layer and of additional layers of the layers of the multi-layered virtual computation module, other than the first cluster, the identification component identifies an additional outlier neuron for each cluster of the plurality of clusters of the first layer and of the additional layers; and for the plurality of clusters of the first layer and of the additional layers, the adjustment component reassigns each outlier neuron of the additional outlier neurons to a different cluster of a same layer, of the layers, comprising the cluster initially having the outlier neuron.

The system of any previous paragraph, wherein the cross-layer functionality is further adjustably varied, by the scheduling component, based on a dependency between neurons of different layers of the multi-layered virtual computation module.

The system of any previous paragraph, further comprising: a derived field extractor component that classifies derived fields corresponding to the looped neurons; and a neuron extractor component that, employing classifications of the classified derived fields, assigns the classifications to the looped neurons.

The system of any previous paragraph, further comprising: a neuron clustering component that groups the looped neurons into clusters based on results of the assigning of the classifications to the looped neurons; and a layering component that defines the layers of the multi-layered virtual computation module by grouping the clusters into the layers.

A computer-implemented method, comprising: employing, by a system comprising a memory operatively coupled to a processor, an operating, multi-layered virtual computation module of looped neurons; identifying, by the system, a first neuron of a first cluster of a first layer of the looped neurons as being an outlier neuron; reassigning, by the system, the outlier neuron from the first cluster to a second cluster of the first layer; and based on a dependency among layers of the multi-layered virtual computation module, including the first layer, adjusting, by the system, a cross-layer functionality of the looped neurons for a workload currently being performed by the multi-layered virtual computation module.

The computer-implemented method of the previous paragraph, wherein the identifying, that the first neuron is an outlier neuron, is based on the first neuron having a run time that is statistically different than other neurons, of the looped neurons, of the first cluster.

The computer-implemented method of any previous paragraph, further comprising: employing, by the system, an adjusted multi-layered virtual computation module resulting from the adjustment performed by the scheduling component; and generating, by the system, a prediction based on data input into the adjusted multi-layered virtual computation module.

The computer-implemented method of any previous paragraph, further comprising: for a plurality of clusters of the first layer and of additional layers of the layers of the multi-layered virtual computation module, other than the first cluster, identifying, by the system, an additional outlier neuron for each cluster of the plurality of clusters of the first layer and of the additional layers; and for the plurality of clusters of the first layer and of the additional layers, reassigning, by the system, each outlier neuron of the additional outlier neurons to a different cluster of a same layer, of the layers, comprising the cluster initially having the outlier neuron.

The computer-implemented method of any previous paragraph, wherein the cross-layer functionality is further adjustably varied based on a dependency between neurons of different layers of the multi-layered virtual computation module.

The computer-implemented method of any previous paragraph, further comprising classifying, by the system, derived fields corresponding to the looped neurons; and employing, by the system, classifications of the classified derived fields, assigning, by the system the classifications to the looped neurons.

The computer-implemented method of any previous paragraph, further comprising grouping, by the system, the looped neurons into clusters based on results of the assigning of the classifications to the looped neurons; and defining, by the system, the layers of the multi-layered virtual computation module by grouping the clusters into the layers

A computer program product facilitating a process to optimize performance of an operating neural network, the computer program product comprising a computer readable storage medium having program instructions embodied therewith, the program instructions executable by a processor operatively coupled to a memory to cause the processor to: employ, by the processor, an operating, multi-layered virtual computation module of looped neurons; identify, by the processor, a first neuron of a first cluster of a first layer of the looped neurons as being an outlier neuron; reassign, by the processor, the outlier neuron from the first cluster to a second cluster of the first layer; and based on a dependency among layers of the multi-layered virtual computation module, including the first layer, adjust, by the processor, a cross-layer functionality of the looped neurons for a workload currently being performed by the multi-layered virtual computation module.

The computer program product of the previous paragraph, wherein the identifying, that the first neuron is an outlier neuron, is based on the first neuron having a run time that is statistically different than other neurons, of the looped neurons, of the first cluster.

The computer program product of any previous paragraph, wherein the program instructions are further executable by the processor to cause the processor to: employ, by the processor, an adjusted multi-layered virtual computation module resulting from the adjustment performed by the scheduling component; and generate, by the processor, a prediction based on data input into the adjusted multi-layered virtual computation module.

The computer program product of any previous paragraph, wherein the program instructions are further executable by the processor to cause the processor to: for a plurality of clusters of the first layer and of additional layers of the layers of the multi-layered virtual computation module, other than the first cluster, identify, by the processor, an additional outlier neuron for each cluster of the plurality of clusters of the first layer and of the additional layers; and for the plurality of clusters of the first layer and of the additional layers, reassign, by the processor, each outlier neuron of the additional outlier neurons to a different cluster of a same layer, of the layers, comprising the cluster initially having the outlier neuron.

The computer program product of any previous paragraph, wherein the cross-layer functionality is further adjustably varied based on a dependency between neurons of different layers of the multi-layered virtual computation module.

The computer program product of any previous paragraph, wherein the program instructions are further executable by the processor to cause the processor to classify, by the processor, derived fields corresponding to the looped neurons; employ, by the processor, classifications of the classified derived fields, assigning, by the system the classifications to the looped neurons; group, by the processor, the looped neurons into clusters based on results of the assigning of the classifications to the looped neurons; and define, by the processor, the layers of the multi-layered virtual computation module by grouping the clusters into the layers.

### Computing Environment Description

Turning next to FIG. 25, a detailed description is provided of additional context for the one or more embodiments described herein at FIGS. 1-24.

FIG. 25 and the following discussion are intended to provide a brief, general description of a suitable computing environment 2500 in which one or more embodiments described herein at FIGS. 1-24 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 2500 contains an example of an environment for the execution of at least some of the computer code involved in performing the inventive methods, such as translation of an original source code based on a configuration of a target system by the neural generation and neural network generation and prediction processing code 2580. In addition to block 2580, computing environment 2500 includes, for example, computer 2501, wide area network (WAN) 2502, end user device (EUD) 2503, remote server 2504, public cloud 2505, and private cloud 2506. In this embodiment, computer 2501 includes processor set 2510 (including processing circuitry 2520 and cache 2521), communication fabric 2511, volatile memory 2512, persistent storage 2513 (including operating system 2522 and block 2580, as identified above), peripheral device set 2514 (including user interface (UI), device set 2523, storage 2524, and Internet of Things (IoT) sensor set 2525), and network module 2515. Remote server 2504 includes remote database 2530. Public cloud 2505 includes gateway 2540, cloud orchestration module 2541, host physical machine set 2542, virtual machine set 2543, and container set 2544.

COMPUTER 2501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 2530. As is well understood in the art of computer technology, and depending upon the technology, performance of a computer-implemented method may be distributed among multiple computers and/or between multiple locations. On the other hand, in this presentation of computing environment 2500, detailed discussion is focused on a single computer, specifically computer 2501, to keep the presentation as simple as possible. Computer 2501 may be located in a cloud, even though it is not shown in a cloud in FIG. 25. On the other hand, computer 2501 is not required to be in a cloud except to any extent as may be affirmatively indicated.

PROCESSOR SET 2510 includes one, or more, computer processors of any type now known or to be developed in the future. Processing circuitry 2520 may be distributed over multiple packages, for example, multiple, coordinated integrated circuit chips. Processing circuitry 2520 may implement multiple processor threads and/or multiple processor cores. Cache 2521 is memory that is located in the processor chip package and is typically used for data or code that should be available for rapid access by the threads or cores running on processor set 2510. Cache memories are typically organized into multiple levels depending upon relative proximity to the processing circuitry. Alternatively, some, or all, of the cache for the processor set may be located “off chip.” In some computing environments, processor set 2510 may be designed for working with qubits and performing quantum computing.

Computer readable program instructions are typically loaded onto computer 2501 to cause a series of operational steps to be performed by processor set 2510 of computer 2501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 2521 and the other storage media discussed below. The program instructions, and associated data, are accessed by processor set 2510 to control and direct performance of the inventive methods. In computing environment 2500, at least some of the instructions for performing the inventive methods may be stored in block 2580 in persistent storage 2513.

COMMUNICATION FABRIC 2511 is the signal conduction path that allows the various components of computer 2501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 2512 is any type of volatile memory now known or to be developed in the future. Examples include dynamic type random access memory (RAM) or static type RAM. Typically, the volatile memory is characterized by random access, but this is not required unless affirmatively indicated. In computer 2501, the volatile memory 2512 is located in a single package and is internal to computer 2501, but, alternatively or additionally, the volatile memory may be distributed over multiple packages and/or located externally with respect to computer 2501.

PERSISTENT STORAGE 2513 is any form of non-volatile storage for computers that is now known or to be developed in the future. The non-volatility of this storage means that the stored data is maintained regardless of whether power is being supplied to computer 2501 and/or directly to persistent storage 2513. Persistent storage 2513 may be a read only memory (ROM), but typically at least a portion of the persistent storage allows writing of data, deletion of data and re-writing of data. Some familiar forms of persistent storage include magnetic disks and solid-state storage devices. Operating system 2522 may take several forms, such as various known proprietary operating systems or open-source Portable Operating System Interface type operating systems that employ a kernel. The code included in block 2580 typically includes at least some of the computer code involved in performing the inventive methods.

PERIPHERAL DEVICE SET 2514 includes the set of peripheral devices of computer 2501. Data communication connections between the peripheral devices and the other components of computer 2501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 2523 may include components such as a display screen, speaker, microphone, wearable devices (such as goggles and smart watches), keyboard, mouse, printer, touchpad, game controllers, and haptic devices. Storage 2524 is external storage, such as an external hard drive, or insertable storage, such as an SD card. Storage 2524 may be persistent and/or volatile. In some embodiments, storage 2524 may take the form of a quantum computing storage device for storing data in the form of qubits. In embodiments where computer 2501 is required to have a large amount of storage (for example, where computer 2501 locally stores and manages a large database) then this storage may be provided by peripheral storage devices designed for storing very large amounts of data, such as a storage area network (SAN) that is shared by multiple, geographically distributed computers. IoT sensor set 2525 is made up of sensors that can be used in Internet of Things applications. For example, one sensor may be a thermometer and another sensor may be a motion detector.

NETWORK MODULE 2515 is the collection of computer software, hardware, and firmware that allows computer 2501 to communicate with other computers through WAN 2502. Network module 2515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 2515 are performed on the same physical hardware device. In other embodiments (for example, embodiments that utilize software-defined networking (SDN)), the control functions and the forwarding functions of network module 2515 are performed on physically separate devices, such that the control functions manage several different network hardware devices. Computer readable program instructions for performing the inventive methods can typically be downloaded to computer 2501 from an external computer or external storage device through a network adapter card or network interface included in network module 2515.

WAN 2502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 2503 is any computer system that is used and controlled by an end user (for example, a customer of an enterprise that operates computer 2501) and may take any of the forms discussed above in connection with computer 2501. EUD 2503 typically receives helpful and useful data from the operations of computer 2501. For example, in a hypothetical case where computer 2501 is designed to provide a recommendation to an end user, this recommendation would typically be communicated from network module 2515 of computer 2501 through WAN 2502 to EUD 2503. In this way, EUD 2503 can display, or otherwise present, the recommendation to an end user. In some embodiments, EUD 2503 may be a client device, such as thin client, heavy client, mainframe computer, desktop computer and so on.

REMOTE SERVER 2504 is any computer system that serves at least some data and/or functionality to computer 2501. Remote server 2504 may be controlled and used by the same entity that operates computer 2501. Remote server 2504 represents the machine that collects and stores helpful and useful data for use by other computers, such as computer 2501. For example, in a hypothetical case where computer 2501 is designed and programmed to provide a recommendation based on historical data, then this historical data may be provided to computer 2501 from remote database 2530 of remote server 2504.

PUBLIC CLOUD 2505 is any computer system available for use by multiple entities that provides on-demand availability of computer system resources and/or other computer capabilities, especially data storage (cloud storage) and computing power, without direct active management by the scale. The direct and active management of the computing resources of public cloud 2505 is performed by the computer hardware and/or software of cloud orchestration module 2541. The computing resources provided by public cloud 2505 are typically implemented by virtual computing environments that run on various computers making up the computers of host physical machine set 2542, which is the universe of physical computers in and/or available to public cloud 2505. The virtual computing environments (VCEs) typically take the form of virtual machines from virtual machine set 2543 and/or containers from container set 2544. It is understood that these VCEs may be stored as images and may be transferred among and between the various physical machine hosts, either as images or after instantiation of the VCE. Cloud orchestration module 2541 manages the transfer and storage of images, deploys new instantiations of VCEs and manages active instantiations of VCE deployments. Gateway 2540 is the collection of computer software, hardware, and firmware that allows public cloud 2505 to communicate via WAN 2502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 2506 is similar to public cloud 2505, except that the computing resources are only available for use by a single enterprise. While private cloud 2506 is depicted as being in communication with WAN 2502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 2505 and private cloud 2506 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an identification component that, employing an operating, multi-layered virtual computation module of looped neurons, identifies a first neuron of a first cluster of a first layer of the looped neurons as being an outlier neuron;
an adjustment component that reassigns the outlier neuron from the first cluster to a second cluster of the first layer; and
a scheduling component that, based on a dependency among layers of the multi-layered virtual computation module, including the first layer, adjusts a cross-layer functionality of the looped neurons for a workload currently being performed by the multi-layered virtual computation module.

2. The system of claim 1, wherein the identifying, by the identification component, that the first neuron is an outlier neuron, is based on the first neuron having a run time that is statistically different than other neurons, of the looped neurons, of the first cluster.

3. The system of claim 1, further comprising:
a prediction component that, employing an adjusted multi-layered virtual computation module resulting from the adjustment performed by the scheduling component, generates a prediction based on data input into the adjusted multi-layered virtual computation module.

4. The system of claim 1, wherein
for a plurality of clusters of the first layer and of additional layers of the layers of the multi-layered virtual computation module, other than the first cluster, the identification component identifies an additional outlier neuron for each cluster of the plurality of clusters of the first layer and of the additional layers; and
for the plurality of clusters of the first layer and of the additional layers, the adjustment component reassigns each outlier neuron of the additional outlier neurons to a different cluster of a same layer, of the layers, comprising the cluster initially having the outlier neuron.

5. The system of claim 1, wherein the cross layer functionality is further adjustably varied, by the scheduling component, based on a dependency between neurons of different layers of the multi-layered virtual computation module.

6. The system of claim 1, further comprising:
a derived field extractor component that classifies derived fields corresponding to the looped neurons; and
a neuron extractor component that, employing classifications of the classified derived fields, assigns the classifications to the looped neurons.

7. The system of claim 6, further comprising:
a neuron clustering component that groups the looped neurons into clusters based on results of the assigning of the classifications to the looped neurons; and
a layering component that defines the layers of the multi-layered virtual computation module by grouping the clusters into the layers.

8. A computer-implemented method, comprising:
employing, by a system comprising a memory operatively coupled to a processor, an operating, multi-layered virtual computation module of looped neurons;
identifying, by the system, a first neuron of a first cluster of a first layer of the looped neurons as being an outlier neuron,
reassigning, by the system, the outlier neuron from the first cluster to a second cluster of the first layer; and
based on a dependency among layers of the multi-layered virtual computation module, including the first layer, adjusting, by the system, a cross-layer functionality of the looped neurons for a workload currently being performed by the multi-layered virtual computation module.

9. The computer-implemented method of claim 8, wherein the identifying, that the first neuron is an outlier neuron, is based on the first neuron having a run time that is statistically different than other neurons, of the looped neurons, of the first cluster.

10. The computer-implemented method of claim 8, further comprising:
employing, by the system, an adjusted multi-layered virtual computation module resulting from the outlier neuron adjustment and cross-layer functionality adjustment; and
generating, by the system, a prediction based on data input into the adjusted multi-layered virtual computation module.

11. The computer-implemented method of claim 8, further comprising:
for a plurality of clusters of the first layer and of additional layers of the layers of the multi-layered virtual computation module, other than the first cluster, identifying, by the system, an additional outlier neuron for each cluster of the plurality of clusters of the first layer and of the additional layers; and
for the plurality of clusters of the first layer and of the additional layers, reassigning, by the system, each outlier neuron of the additional outlier neurons to a different cluster of a same layer, of the layers, comprising the cluster initially having the outlier neuron.

12. The computer-implemented method of claim 8, wherein the cross layer functionality is further adjustably varied based on a dependency between neurons of different layers of the multi-layered virtual computation module.

13. The computer-implemented method of claim 8, further comprising:
classifying, by the system, derived fields corresponding to the looped neurons; and
employing classifications of the classified derived fields, assigning, by the system the classifications to the looped neurons.

14. The computer-implemented method of claim 13, further comprising:
grouping, by the system, the looped neurons into clusters based on results of the assigning of the classifications to the looped neurons; and
defining, by the system, the layers of the multi-layered virtual computation module by grouping the clusters into the layers.

15. A computer program product facilitating a process to optimize performance of an operating neural network, the computer program product comprising a computer readable storage medium having program instructions embodied therewith, the program instructions executable by a processor operatively coupled to a memory to cause the processor to:
employ, by the processor, an operating, multi-layered virtual computation module of looped neurons;
identify, by the processor, a first neuron of a first cluster of a first layer of the looped neurons as being an outlier neuron,
reassign, by the processor, the outlier neuron from the first cluster to a second cluster of the first layer; and
based on a dependency among layers of the multi-layered virtual computation module, including the first layer, adjust, by the processor, a cross-layer functionality of the looped neurons for a workload currently being performed by the multi-layered virtual computation module.

16. The computer program product of claim 15, wherein the identifying, that the first neuron is an outlier neuron, is based on the first neuron having a run time that is statistically different than other neurons, of the looped neurons, of the first cluster.

17. The computer program product of claim 15, wherein the program instructions are further executable by the processor to cause the processor to:
employ, by the processor, an adjusted multi-layered virtual computation module resulting from the outlier neuron adjustment and cross-layer functionality adjustment; and
generate, by the processor, a prediction based on data input into the adjusted multi-layered virtual computation module.

18. The computer program product of claim 16, wherein the program instructions are further executable by the processor to cause the processor to:
for a plurality of clusters of the first layer and of additional layers of the layers of the multi-layered virtual computation module, other than the first cluster, identify, by the processor, an additional outlier neuron for each cluster of the plurality of clusters of the first layer and of the additional layers; and
for the plurality of clusters of the first layer and of the additional layers, reassign, by the processor, each outlier neuron of the additional outlier neurons to a different cluster of a same layer, of the layers, comprising the cluster initially having the outlier neuron.

19. The computer program product of claim 15, wherein the cross layer functionality is further adjustably varied based on a dependency between neurons of different layers of the multi-layered virtual computation module.

20. The computer program product of claim 15, wherein the program instructions are further executable by the processor to cause the processor to:
classify, by the processor, derived fields corresponding to the looped neurons;
employ, by the processor, classifications of the classified derived fields, assigning, by the system the classifications to the looped neurons;
group, by the processor, the looped neurons into clusters based on results of the assigning of the classifications to the looped neurons; and
define, by the processor, the layers of the multi-layered virtual computation module by grouping the clusters into the layers.
